(19) United States
(12) Patent Application Publication
(10) Pub. No.: US 2007/0292567 A1
(43) Pub. Date: Dec. 20, 2007

(54) E-beam cured packaging structure, packages, and methods of making

(75) Inventors: Roger L. Kaas, Sherwood, WI (US); Russ P. Gehrke, Neenah, WI (US); Timothy P. Killoran, San Ramon, CA (US); Sandra Lee Killoran, San Raman, CA (US); Mark Hines, Clayton, CA (US); Gary A. Gassman, Dublin, CA (US)

Correspondence Address: WILHELM LAW SERVICE, S.C., 100 W LAWRENCE ST, THIRD FLOOR, APPLETON, WI, 54911, US

(73) Assignee: Lithotype Company, Inc., South San Francisco, CA (US)

(21) Appl. No.: 11/646,808

(22) Filed: Dec. 27, 2006

Related U.S. Application Data
(60) Provisional application No. 60/755,126, filed on Dec. 30, 2005.

(51) Int. Cl. B65D 85/00; B29D 22/00; B32B 1/08; B65B 55/00

(52) U.S. Cl. 426/106; 264/485; 264/643; 426/410; 428/34.1; 428/35.7; 428/35.8

(57) ABSTRACT

Flexible retort packaging structures, including retort pouches and methods of making both the packaging structures and pouches, wherein an otherwise conventional flexible retort substrate is surface printed, the printed image is optionally overcoated with a protective overcoating material. The printing is accordingly located outwardly of the outer structural layer of the substrate and an overcoating is optionally applied over the printing, such that the printed image is between the optional overcoating and the outer-most structural layer of the substrate. The printed images and optional overcoating are simultaneously cured in an electron beam irradiation process.

### BACKGROUND

This invention relates generally to retort packaging, and optionally to supplying retort packaging materials to users of such packaging in quantities which are not economically feasible using conventional packaging-making technology.

“Retort packaging” as used herein generally contemplates packaging structure which defines one or more walls which completely surround, and enclose, a product-containing cavity which contains the product being packaged. The overall cross-sectional thickness of at least a portion of the wall structure which surrounds the cavity is a flexible material having a thickness of, for example and without limitation, about 2 mils (0.002 inch) (0.05 mm) to about 20 mils (0.020 inch) (0.5 mm), typically about 2 mils (0.002 inch) (0.05 mm) to about 10 mils (0.010 inch) (0.25 mm).

A retort packaging structure typically has at least a sealant layer, typically polypropylene, on a first outer surface, and a biaxially oriented polyester, or other abuse-resistant layer, on an opposing outer surface. The abuse resistant layer is typically a polyester layer, optionally a polyethylene terephthalate (PET), though other materials, including other polyesters which provide suitable retort-tolerant properties, are contemplated in the invention. A barrier defined by one or more layers of e.g. metal foil, aluminum oxide (AlOₓ), silicon oxide (:SiOₓ), polyvinylidene chloride, ethylene vinyl alcohol copolymer, or a second biaxially-oriented polyester layer which bears a barrier layer, is typically, but not necessarily, positioned between the sealant layer and the outer polyester layer.

In conventional packaging-making technology for production of a flexible retort packaging structure, the sealant layer, the outer polyester layer, and the barrier layer, and any other layers in the structure, are secured to each other by well-known adhesive lamination processes. Any other layers used in the packaging structure are typically also combined into the structure using adhesive lamination processes.

A conventional and well accepted function of packaged products is that the packaging carries a variety of messages which convey information pertaining to the contained product. Indeed, many packages are required to carry certain government-mandated information pertaining to the contained product. Such information is typically incorporated into the packaging material in one or more printed layers.

Conventional processes for making retort packaging include reverse printing the outer polyester layer with the desired graphics and/or other information before the outer polyester layer is adhesively laminated to the adjacent layer or layer combination, to make the finished flexible retort packaging material whereby, in the resulting structure, the outer polyester layer is between the printing and the outer surface of the packaging structure. The reverse printed structure thus employs the outer polyester layer as a protector of the printed image.

While the reverse printed structure enjoys the benefits of a protected image, the recited reverse printing process incurs a number of consequences which negatively impact the cost of producing flexible retort packaging structures.

First, the printing must be done before the final adhesive lamination step can be performed, whereby the lead time required to produce an order of packaging material, and to ship the resulting fabricated packaging structures is dependent on, among other things, access to manufacturing time on both the printing machines and the adhesive lamination machines whereby both the printing machines and the lamination machines are critical path elements in the manufacturing process. If these two operations are performed at different manufacturing locations, then transportation time between the two manufacturing locations also becomes an element of critical path timing. Thus, in fabricating conventional retort structures, the printing steps and the adhesive lamination steps are typically performed in a single manufacturing facility, or in closely adjacent manufacturing facilities.

Also, after lamination, there is a curing time required for the adhesive to develop sufficient strength and heat resistance to allow handling in subsequent steps. This curing time can be, for example and without limitation, four days to ten days for the typical adhesives used for retort packaging, which adds that much more time to the critical path timing.

In addition, in order to produce finished flexible retort structures, the manufacturer must have sufficient capital to secure access to both printing machines and adhesive lamination machines, whereby the cost of entry into the business of manufacturing flexible retort structures is driven, at least in part, by the capital costs related to both lamination and printing.

Further, the manufacturer of flexible retort structures must secure access to the technical know-how related to both printing processes and adhesive lamination processes, as well as securing access to know-how related to the retort processing environment.

Still further, since the printing is conventionally a necessary step in constructing the adhesive lamination, the minimum size of a production run is affected by both the cost of setting-up for a printing operation and the cost of setting-up for an adhesive lamination operation for each unique order of packaging material, each of which set-ups is uniquely identified to the particular production run or order being contemplated.

In this invention, it is desirable to provide retort structures and processes which enable operating with shorter lead times to produce an ordered product, and wherein the printing steps and the adhesive lamination steps can cost-effectively be performed in different manufacturing facilities which can be separated by substantial distances, such as in different cities, and wherein the adhesive lamination steps, including curing of the adhesive, and the transportation step, are not critical path items in the process of supplying flexible retort structures in response to a customer order.

It is further desirable to provide retort structures and processes which have lower capital demand for the manufacturer of the finished flexible retort structures, whereby the cost of entry into the business of making and supplying flexible retort structures is reduced, thereby introducing additional competition to the marketplace.

It is yet further desirable to provide retort structures and processes which limit the manufacturing know-how which is required of the manufacturer of the finished flexible retort structure to printing and coating know-how, and retort packaging know how, with lesser, if any, requirement for know-how related to adhesive lamination.

It is still further desirable to provide retort structures and processes which enable cost-effective production of lower quantities of a given flexible retort structure, thereby enabling packaging users and consumers to benefit from entry of lower-volume retort-packaged products into the commercial marketplace.

It is further desirable to provide a process for fabricating retort packaging structure wherein the finished retort structure, except for applying and protecting the graphics imaging, can be fabricated in production runs from which multiple finished product orders for different products, e.g. different print specifications, subsequently identified to the specific retort packaging structure, can be fulfilled.

As used herein, “retort”, “retort packaging”, “retort processing”, “retort package”, and the like refer to a heat treatment process which is used to bring the contents of the package to a “commercially sterile” condition. In such process, the packaged products are subjected to hot water under a pressurized atmosphere such that the water is in the liquid state at temperatures above the atmospheric boiling temperature of water, which is nominally 212 degrees F.

Thus, retort processing always refers to temperatures greater than 212 degrees F. Typical retort processing temperatures are from about 240 degrees F. to about 275 degrees F. Most commonly, retort processing is practiced at about 250 degrees F.

“Commercially sterile” means that the packaged product has been held at a specified minimum temperature for a specified minimum time, sufficient to kill substantially all pathologically destructive organisms. The specified temperatures and times vary according to the product contents of the package, as is known to those skilled in the art.

The actual period of time a package needs to be exposed to such heat treatment process to reach “commercially sterile” condition depends on a number of factors such as the processing temperature, the layout and functioning of the processing equipment, package size and configuration, nature of the product contained in the package, and the like. A processing time as short as 5 minutes, or 10 minutes, can be adequate in some instances where the overall package thickness is quite small. However, retort processing time is typically about 30 minutes to about 60 minutes.

The retorted package should be generally physically stable under retort conditions such that the appearance of the package is acceptable to the typical consumer after retort processing. Namely, the package is not deleteriously distorted, wrinkled, puckered, or otherwise damaged, and provides a commercially-acceptable presentation of the so-processed package.

A well-accepted definition of retort processing, acceptable for use herein, is set forth in a US government publication, namely 21 Code of Federal Regulations 176.170 “Components of Paper and Paperboard in Contact with Aqueous and Fatty Foods”, at Table 2, Condition of Use “A”, “High Temperature Heat Sterilized Over 212 degrees F”.

### SUMMARY OF THE INVENTION

In general, this invention provides flexible retort structures wherein an otherwise conventional flexible retort structure is surface printed with e.g. a relatively higher viscosity acrylic precursor type of ink, and the printed images are typically, but not necessarily, overcoated with an acrylic precursor type, relatively lower viscosity, liquidous overcoating such as a varnish. Thus, the printing is typically located outwardly of the outer structural layer of the substrate, e.g. polyester layer, and an overcoating is applied over the printing, such that the printed image is between the overcoating and the outer-most polyester layer. The printed images and overcoating are simultaneously cured in an electron beam irradiation process. Where the ink contains a sufficiently robust polymer carrier, or sufficient quantity of polymer as part of the printed image, the overcoating can be omitted.

In a first family of embodiments, the invention contemplates retortable flexible packaging structure, comprising a multiple layer substrate which, when assembled into a retortable package, is compatible with retort processing, the multiple layer substrate having a first surface which is defined by a first surface layer which is heat sealable, and a second opposing outer surface defined by a second surface layer, the second surface layer having an outer surface which corresponds with the second outer surface of the substrate; and a first coating on the second outer surface of the multiple layer substrate, the first coating comprising a printed image, the printed image having been derived from a reaction-curable ink, the printed and overcoated flexible packaging structure, when assembled into a retort package, being compatible with being retort processed.

In some embodiments, the one or more reaction curable ink precursors are reactable such that substantially all of such reaction curable ink precursors are converted to solid state when cured.

In some embodiments, the one or more reaction curable ink precursors comprise E-beam curable ink precursors.

In some embodiments the packaging structure further comprises an overcoating overlying the printed image, the overcoating having been derived from one or more reaction curable overcoating precursors, optionally a radiation curable transparent polymeric material precursor, optionally a varnish, and wherein the one or more curable overcoating precursors are reactable such that substantially 100 percent of such reaction curable overcoating precursors are converted to solid state when cured.

In some embodiments, the outer surface of the second layer bears the results of a surface treatment, optionally a chemical treatment, optionally an acrylic or pre-acrylic chemical treatment, which enhances adhesion of the respective outer surface with respect to certain materials which contact the respective treated outer surface.

In some embodiments, the first coating on the second surface reflects having been electron-beam cured at a dosage of about 2 mega rads to about 10 mega rads.

In some embodiments, the composition of the second surface layer comprises at least one of polyester and nylon, optionally at least one of oriented polyethylene terephthalate and oriented nylon.

In some embodiments, the retortable flexible package structure has an average thickness of about 0.0025 inch to about 0.020 inch, optionally about 0.004 inch to about 0.010 inch, optionally about 0.0045 inch to about 0.006 inch.

The overcoating is optionally derived from one or more E-beam curable overcoating precursors.

In some embodiments, the substrate further comprises a barrier layer, the barrier layer comprising a material selected from the group consisting of a metal foil layer, an AlOₓ layer, and a SiOₓ layer.

In a second family of embodiments, the invention comprehends a retort package, comprising packaging, the packaging comprising a retortable multiple layer flexible packaging structure comprising (i) a substrate, the substrate comprising an outer structural layer, the outer structural layer having an inwardly-facing surface facing toward an inner cavity in the retort package and an outwardly-facing surface facing away from the retort package, and (ii) a first coating being disposed on the outwardly-facing surface of the substrate, the first coating comprising a printed image, the printed image having been derived from a reaction curable ink precursor; and a retort-processed product contained in the package, the retort package reflecting having been retort processed.

In some embodiments, the retort package further comprises an overcoating overlying the printed image, the overcoating having been derived from a reaction curable overcoating precursor, and wherein such reaction curable overcoating precursor was reactable such that substantially all of such reaction curable overcoating precursor was converted to solid state when cured.

In a third family of embodiments, the invention comprehends a method of producing retortable flexible packaging structure. The method comprises securing a supply of a multiple layer substrate material which, when assembled into a retortable package, is compatible with retort processing, the multiple layer substrate having a first outer surface which is defined by a first surface layer which is heat sealable, and a second opposing outer surface which is defined by a second surface layer, the second surface layer having an outer surface which corresponds with the second outer surface of the substrate material; making a first draw of less than all of the supply of substrate material from the supply, and coating a first printed image onto the second outer surface of the first drawn substrate material, optionally applying an overcoating over the first printed image, using first printing machinery, and ink, thus to make a first finished flexible retort packaging structure which, when assembled into a retort package, is compatible with being retort processed; sending the first finished flexible retort packaging structure to a first user of flexible retort packaging structure; making a second draw of the substrate material from the supply of substrate material, and coating a second printed image onto the second outer surface of the second drawn substrate material, optionally applying an overcoating over the second printed image, using second printing machinery, and ink, thus to make a second finished flexible retort packaging structure which, when assembled into a retort package, is compatible with being retort processed; and sending the second finished flexible retort packaging structure to a second user of flexible retort packaging structure,

the method further comprises at least one of (i) the second printed image is different from the first printed image, or (ii) the second user is different from the first user, or (iii) the second printing machinery is the same as the first printing machinery, further comprising printing a different product on the respective printing machinery between printing the first and second printed images.

In some embodiments, the substrate has an average thickness of about 0.0025 inch to about 0.020 inch, optionally about 0.004 inch to about 0.010 inch, optionally about 0.0045 inch to about 0.06 inch.

In some embodiments, the composition of said second surface layer comprises at least one of polyester and nylon, optionally at least one of oriented polyethylene terephthalate and oriented nylon.

In some embodiments, the inks are reactable such that substantially all of the inks are converted to solid state when cured, for example the inks are E-beam curable inks.

In some embodiments, the optional overcoatings are reactable such that substantially all of the overcoating is converted to solid state when cured, for example the optional overcoatings are E-beam curable overcoatings.

In some embodiments, the method further comprises treating the second outer surface with a surface treatment, for example a chemical treatment, for example an acrylic or pre-acrylic surface treatment, which enhances adhesion of the second outer surface with respect to the inks.

In some embodiments, the multiple layer substrate material further comprises a barrier layer, the barrier layer comprising a material selected from the group consisting of a metal foil layer, an AlOₓ layer, and a SiOₓ layer.

In a fourth family of embodiments, the invention comprehends a method of producing a retortable flexible packaging structure. The method comprises securing a supply of a multiple layer substrate material which is compatible with retort processing when assembled into a retortable package, the multiple layer substrate having a first outer surface, defined by a first surface layer which is heat sealable, and a second opposing outer surface which is defined by a second surface layer, the second surface layer having an outer surface which corresponds with the second outer surface of the substrate material; surface printing an ink image on the second outer surface at the second surface layer; and curing the printed ink image by exposing the printed ink image to electron-beam irradiation of about 2 mega rads to about 10 mega rads and thereby obtaining a cured ink coating which is tolerant of retort processing conditions, thereby obtaining a retortable flexible packaging structure which, when assembled into a retortable package, is compatible with being retort processed.

In some embodiments, the method further comprises, prior to curing the printed ink image, overcoating the printed ink image with an E-beam curable transparent overcoating, and subsequently practicing the curing step by simultaneously exposing both the printed ink image and the overcoating to E-beam radiation at an irradiation dosage of about 2 mega rads to about 10 mega rads.

In some embodiments, the substrate has an average thickness of about 0.0025 inch to about 0.020 inch, optionally about 0.004 inch to about 0.010 inch, optionally about 0.0045 inch to about 0.006 inch.

In some embodiments, the ink is E-beam curable ink.

In some embodiments, the method further comprises treating the second outer surface with a surface treatment, optionally a chemical treatment, optionally an acrylic or pre-acrylic treatment, which enhances adhesion of the second outer surfaces with respect to the ink.

In some embodiment, the multiple layer substrate material further comprises a barrier layer, the barrier layer comprising a material selected from the group consisting of a metal foil layer, an AlOₓ layer, and a SiOₓ layer.

In a fifth family of embodiments, the invention comprehends a method of making a flexible retortable packaging structure, comprising securing a supply of a flexible packaging substrate which, when assembled into a retortable package, is compatible with retort processing, said flexible packaging substrate having a first outer surface which is defined by a first layer which is heat sealable, and a second opposing outer surface which is defined by a second surface layer, the second surface layer having an outer surface which corresponds with the second outer surface of the flexible packaging substrate; after securing the supply of substrate, identifying a quantity of a product to be produced using the substrate; printing a printed image on the second outer surface, using E-beam curable ink; overcoating the printed image with a second E-beam curable overcoating material; and E-beam curing both the E-beam curable ink and the E-beam curable overcoating material, thereby obtaining a retortable packaging structure, including substrate, E-beam cured ink, and E-beam cured overcoating over the E-beam cured ink, and wherein the retortable packaging structure, when assembled into a retortable package, is compatible with retort processing.

In a sixth family of embodiments, the invention comprehends a method of making a flexible retortable package, comprising securing a supply of a flexible packaging substrate which, when assembled into a retortable package, is compatible with retort processing, the flexible packaging substrate having a first outer surface which is defined by a first layer which is heat sealable, and a second opposing outer surface which is defined by a second surface layer, the second surface layer having an outer surface which corresponds with the second outer surface of the flexible packaging substrate; after securing the supply of substrate, identifying a quantity of a product to be produced using the substrate; printing a printed image on the second outer surface, using E-beam curable ink; overcoating the printed image with a second E-beam curable overcoating material; E-beam curing both the E-beam curable ink and the E-beam curable overcoating material; and heat sealing portions of the heat sealable layer thereby to fabricate a resultant retortable package, the package defining a product-receiving cavity, and an opening extending from the cavity to the outside environment, the resultant retortable package being compatible with retort processing.

In a seventh family of embodiments, the invention comprehends a packaged food product, comprising a food product; a retortable packaging structure enclosing the food product, the packaging structure comprising (i) a substrate film comprising one or more thermoplastic materials, and optionally a non-polymeric barrier layer, the substrate film having a print side, and an opposing food side and an average thickness of less than about 0.025 inch, the substrate film, when assembled into a retort package, being compatible with being heat sealed to itself, and tolerating retort processing; (ii) an image printed on the print side of the substrate film; (iii) an E-beam-cured overcoating over the printed image, the E-beam-cured coating having been formed by coating the printed image with an E-beam-curable overcoating material comprising one or more polymerizable reactants, wherein the E-beam-curable overcoating material includes less than about 20 percent by weight monofunctional monomer based on weight of the E-beam-curable overcoating material, and subsequently exposing the E-beam-curable overcoating material to radiation sufficient to polymerize at least 90 percent by weight of the one or more polymerizable reactants,

and wherein, when the coated, printed, and cured film is tested according to FDA migration test protocol, no more than 50 parts per billion total of any of the polymerizable reactants migrate within 10 days at 40 degrees C. from the coated, printed package into a food stimulant selected from the group consisting of (i) 95 weight percent ethanol and 5 weight percent water and (ii) 5 weight percent ethanol and 95 weight percent water, the food stimulant being enclosed within a test container formed from the coated, printed film so that the food stimulant contacts the food side of the substrate film and the ratio of volume of food stimulant to surface area of coated, printed film is 10 milliliters per square inch.

In some embodiments, the package comprises one or more heat-sealed regions, at least a portion of the E-beam-cured overcoating material extends into the heat-sealed region, and the weight of the E-beam-cured overcoating material per unit area of substrate film in the portion of the E-beam-cured overcoating material extending into the heat-sealed region is at least substantially equal to the weight of the E-beam-cured overcoating material per unit area of substrate film outside the heat-sealed region.

In some embodiments, the package comprises one or more heat-sealed regions, at least a portion of the printed image extends into the heat-sealed region, and the weight of printed image per unit area of substrate film of the portion of the printed image extending into the heat-sealed region is at least substantially equal to the weight of printed image per unit area of substrate film outside the heat-sealed region.

In some embodiments, the gloss of the coated, printed film in the heat-sealed regions is at least substantially equal to the gloss of the coated, printed film outside the heat-sealed region.

In some embodiments, the substrate film has an average thickness of about 0.0025 inch to about 0.020 inch, optionally about 0.004 inch to about 0.010 inch, optionally about 0.0045 inch to about 0.006 inch.

In some embodiments, the package enclosing the food product comprises a vertical form-fill-seal package or a horizontal form-fill-seal package, optionally a pre-made pouch open on one side.

In some embodiments, the package enclosing the food product includes a lid comprising the coated, printed film.

In some embodiments, the average thickness of the E-beam cured overcoating material is less than about 5 micrometers.

In some embodiments, the E-beam curable overcoating material, prior to curing, comprises less than 20 percent by weight, optionally less than about 10 percent by weight, optionally less than about 5 percent by weight, and in some instances is essentially free from monofunctional monomer.

In some embodiments, the E-beam curable overcoating material, prior to curing, is essentially free from reactive diluent.

In some embodiments, the packaged food product further comprises an outer layer defining the print side of the substrate film and wherein the composition of the outer layer comprises at least one of polyester and nylon, optionally at least one of oriented polyethylene terephthalate and oriented nylon.

In some embodiments, the printed image is derived from one or more reaction curable ink precursors which are reactable such that substantially all of such reaction curable ink precursors are converted to solid state when cured.

In some embodiments, the one or more reaction curable ink precursors comprise E-beam curable ink precursors.

In some embodiments, the E-beam-cured overcoating has been derived from one or more overcoating precursors and wherein substantially all of such overcoating precursors have been converted to solid state by the E-beam-curing process, and wherein the E-beam-cured overcoating is derived from a transparent polymeric material precursor, for example a varnish.

In some embodiments, the printed image reflects having been E-beam-cured at a dosage of about 2 mega rads to about 10 mega rads.

In some embodiments a non-polymeric barrier layer comprises a material selected from the group consisting of a metal foil layer, an AlOₓ layer, and a SiOₓ layer.

In an eighth family of embodiments, the invention comprehends a method of packaging food, comprising providing a substrate film comprising one or more thermoplastic materials, and optionally a non-polymeric barrier layer, the substrate film having a print side and an opposing food side, and having an average thickness of less than about 0.025 inch, such substrate film, when assembled into a retort package, being compatible with being heat sealed to itself, and tolerating retort processing; printing an image on the print side of the substrate film; coating the printed image with an E-beam-curable overcoating material comprising one or more polymerizable reactants, wherein the E-beam-curable overcoating material comprises less than about 20 percent by weight monofunctional monomer based on the weight of the E-beam-curable overcoating material; subsequently exposing the E-beam-curable overcoating material to E-beam radiation sufficient to polymerize at least 90 percent by weight of the one or more polymerizable reactants to produce a coated, printed film comprising an E-beam-cured overcoating material, and wherein

when the coated, printed, and cured film is tested according to FDA migration test protocol, no more than 50 parts per billion total of any of the polymerizable reactants migrate within 10 days at 40 degrees C. from the coated, printed film into a food simulant selected from the group consisting of (i) 95 percent by weight ethanol and 5 percent by weight water and (ii) 5 weight percent ethanol and 95 percent by weight water, the food simulant being enclosed within a test container formed from the coated, printed film so that the food simulant contacts the food side of the substrate film and the ratio of volume of food simulant to surface area of coated, printed film is 10 milliliters per square inch; and

forming a package comprising the coated, printed film; and enclosing a food within the package so that the food side of the substrate film faces the enclosed food.

In some embodiments, the forming step comprises heat sealing the coated, printed film to form one or more heat-sealed regions, wherein at least a portion of the E-beam cured overcoating material extends into the heat-sealed region and the weight of the E-beam-cured overcoating material per unit area of substrate film in the portion of the E-beam-cured overcoating material extending into the heat-sealed region is at least equal to the weight of the E-beam-cured overcoating material per unit area of substrate film outside the heat-sealed region.

In some embodiments, the forming step comprises heat sealing the coated, printed film to form one or more heat-sealed regions, wherein at least a portion of the E-beam cured printed image extends into the heat-sealed region and the weight of the E-beam-cured printed image per unit area of substrate film in the portion of the E-beam-cured printed image extending into the heat-sealed region is at least equal to the weight of the E-beam-cured printed image per unit area of substrate film outside the heat-sealed region.

In some embodiments, substrate film has an average thickness of about 0.0025 inch to about 0.020 inch, optionally about 0.004 inch to about 0.010 inch, optionally about 0.0045 inch to about 0.006 inch.

In some embodiments, the printing comprises applying one or more E-beam-curable inks to the print side of the substrate film and applying E-beam radiation and thereby curing the one or more inks.

In some embodiments, forming the package comprises making a vertical form-fill-sealed package or a horizontal form-fill-seal package, optionally a pre-made pouch open on one side.

In some embodiments, the package comprises a lid comprising the printed and overcoated film.

In some embodiments, average thickness of the E-beam-cured overcoating material is no more than about 5 micrometers.

In some embodiments, the E-beam-curable overcoating material, prior to curing, comprises less than 20 percent by weight, optionally less than about 10 percent by weight, optionally less than about 5 percent by weight, optionally less than about 2 percent by weight monofunctional monomer based on the weight of the E-beam-curable overcoating material, and in some embodiments the E-beam-curable overcoating material, prior to curing, is essentially free from monofunctional monomer, and optionally essentially free from reactive diluent.

In some embodiments, the method further comprises heating the package at retort conditions, thereby to cook the food contained in the package to commercially sterile condition.

In some embodiments, the method further comprises an outer layer on the print side of the substrate film and wherein the composition of the outer layer comprises at least one of polyester and nylon, optionally at least one of oriented polyethylene terephthalate and oriented nylon.

In some embodiments, the printed image is derived from an ink which is reaction curable, optionally E-beam-curable, and wherein optionally substantially all of the ink is converted to solid state when cured.

In some embodiments the method comprises treating the print side with a surface treatment, optionally a chemical surface treatment, optionally an acrylic or pre-acrylic surface treatment, which enhances adhesion of the print side with respect to the ink.

In some embodiments the non-polymeric barrier layer comprises a material selected from the group consisting of a metal foil layer, an AlOₓ layer, and a SiOₓ layer.

In a ninth family of embodiments, the invention comprehends a packaged food product, comprising a food product; a retortable package enclosing the food product, the retortable package comprising a coated, printed film comprising (i) a retortable substrate film comprising one or more thermoplastic materials, and optionally a non-polymeric barrier layer, the retortable substrate film having a print side and an opposing food side and an average thickness of less than about 0.025 inch, and being compatible with being heat sealed to itself, and tolerating retort processing, (ii) a retortable image printed on the print side of the retortable substrate film, and (iii) a retortable E-beam-cured overcoating over the printed image, the retortable E-beam-cured coating having been formed by

coating the printed image with an E-beam-curable coating comprising one or more polymerizable reactants and optionally one or more photoinitiators, and

subsequently exposing the E-beam-curable coating to radiation sufficient to polymerize at least 90 percent by weight of the polymerizable reactants, wherein the package comprises one or more heat-sealed regions and at least a portion of the E-beam-cured overcoating extends into the heat-sealed region, and

wherein the weight of the E-beam-cured overcoating per unit area of substrate film in the portion of the E-beam-cured overcoating extending into the heat-sealed region is at least substantially equal to the average of the weight of E-beam-cured overcoating per unit area of substrate film outside of the heat-sealed region.

In some embodiments, at least a portion of the printed image extends into the heat-sealed region, and weight of printed image per unit area of substrate film of a portion of the printed image which extends into the heat-sealed region is at least substantially equal to an average of the weight of printed image per unit area of substrate film outside the heat-sealed region.

In some embodiments the package enclosing the food product comprises a vertical form-fill-sealed package or a horizontal form-fill-seal package, optionally a pre-made pouch open on one side.

In some embodiments, the package enclosing the food product includes a lid comprising the coated, printed film.

In some embodiments, the retortable printed, coated substrate film has a thickness of about 0.0025 inch to about 0.020 inch, optionally about 0.004 inch to about 0.010 inch, optionally about 0.0045 inch to about 0.006 inch.

In some embodiments, the packaged food product further comprises an outer layer defining the print side of the substrate film and wherein the composition of the outer layer comprises at least one of polyester and nylon, optionally at least one of oriented polyethylene terephthalate and oriented nylon.

In some embodiments, the printed image is derived from one or more reaction curable, for example E-beam-curable, ink precursors which are reactable such that substantially all of such reaction curable ink precursors are converted to solid state when cured.

In some embodiments, the E-beam-cured overcoating has been derived from one or more overcoating precursors and substantially all of such overcoating precursors have been converted to solid state by the E-beam-curing process.

In some embodiments, the printed image reflects having been E-beam-cured at a dosage of about 2 mega rads to about 10 mega rads.

In some embodiments, the E-beam-cured overcoating is derived from a transparent polymeric material precursor, for example a varnish.

In some embodiments, a non-polymeric barrier layer in the film comprises a material selected from the group consisting of a metal foil layer, an AlOₓ layer, and a SiOₓ layer.

### BRIEF DESCRIPTION OF THE DRAWINGS

FIG. 1 illustrates a downwardly-looking front pictorial view of a retort of the invention wherein the top side of the pouch is open and ready to receive product.

FIG. 2 illustrates a front elevation view, with a part cut away, of the retort pouch of FIG. 1 after the pouch has been closed and sealed.

FIG. 3 illustrates a representative cross-section of a first prior art flexible retort packaging structure.

FIG. 3A illustrates a representative cross-section of a first flexible retort packaging structure of the invention, wherein the structure substrate resembles a corresponding substrate of the prior art structure illustrated in FIG. 3.

FIG. 3P shows cross-sections of layer subassemblies, in predisposed juxtaposition prior to assembly of the prior art structure of FIG. 3, showing the relative positions of the layers prior to final assembly of the printed polyester to the remaining structural elements of the packaging structure.

FIG. 4 illustrates a representative cross-section of a second prior art flexible packaging retort structure.

FIG. 4A illustrates a representative cross-section of a second flexible retort packaging structure of the invention, wherein the structure substrate resembles a corresponding substrate of the prior art structure illustrated in FIG. 4.

FIG. 5 illustrates a representative cross-section of a third prior art flexible retort packaging structure.

FIG. 5A illustrates a representative cross-section of a third flexible retort packaging structure of the invention, wherein the structure substrate resembles a corresponding substrate of the prior art structure illustrated in FIG. 5.

FIG. 6 illustrates a representative cross-section of a fourth prior art flexible retort packaging structure.

FIG. 6A illustrates a representative cross-section of a fourth flexible retort packaging structure of the invention, wherein the structure substrate resembles a corresponding substrate of the prior art structure illustrated in FIG. 6.

FIG. 7 illustrates a representative cross-section of a fifth prior art flexible retort packaging structure.

FIG. 7A illustrates a representative cross-section of a fifth flexible retort packaging structure of the invention, wherein the structure substrate resembles a corresponding substrate of the prior art structure illustrated in FIG. 7.

FIG. 8 illustrates a representative cross-section of a sixth prior art flexible retort packaging structure.

FIG. 8A illustrates a representative cross-section of a sixth flexible retort packaging structure of the invention, wherein the structure substrate resembles a corresponding substrate of the prior art structure illustrated in FIG. 8.

FIG. 9A illustrates a representative cross-section of a seventh flexible retort packaging structure of the invention, wherein the material of the interior barrier layer between the outer polyester layer and the heat seal layer is polyvinylidene chloride copolymer.

FIG. 10A illustrates a representative cross-section of an eighth flexible retort packaging structure of the invention.

FIG. 11A illustrates a representative cross-section of a ninth flexible retort packaging structure of the invention.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DETAILED DESCRIPTION OF THE ILLUSTRATED EMBODIMENTS

In retort structures and corresponding pouches of the invention, the outer polyester layer is not reverse printed in accord with conventional retort structure technology. Rather, according to the inventive technology of the invention, the outer polyester layer has been adhesively laminated directly to an underlying layer rather than through a printing layer, and is surface printed on that surface of the polyester layer which will be disposed outwardly, in the retort package, away from the cavity which holds the contained product. Given the location of the printing in packaging structures of the invention, the outer polyester layer is between the printing and the heat seal layer.

The ink used for such surface printing is a solvent-less e.g. lithographic printing ink which is tolerant of the retort conditions to which the printed packaging structure is typically exposed. Since the ink is solvent-less, substantially all of the contained precursors, namely substantially 100 percent of the ink, is converted to solid state in the curing process. The ink must exhibit low extractables after curing so as to meet government regulations relating to materials which are used in food packaging.

For example, the finished retort packaging material is wound up in roll form prior to the fabrication of packages from the packaging material such that the printed side of a given layer of the material is in contact with the sealant/contents/food-contact side of the overlying layer of the structure. Such print side-to-heat seal side contact provides opportunity for transfer of any extractable material from the printed side of the structure to the heat seal/food contact side of the structure while the finished structure is being shipped or stored prior to use in making packages. Accordingly, the extractables parameter of the printed side is critical to the structure being able to meet safety requirements related to control of migration of packaging materials into a contained e.g. food product.

The printing is optionally overcoated, for example and without limitation, by a transfer blanket printing cylinder, which carries a heat-tolerant high-gloss overcoating material, such as a reaction-curable acrylic varnish precursor. After applying the printing and overcoating, the newly-applied printing and overcoating are cured by subjecting the respective outer surface of the structure to curing electron-beam (E-beam) radiation at dosage rates of about 2 mega rads to about 10 mega rads, optionally about 3 mega rads to about 5 mega rads of electron beam radiation.

By applying the printing to the outer surface of the outer substrate layer, which is otherwise the outermost structural layer in the packaging structure, no adhesive lamination step is required after the structure is printed.

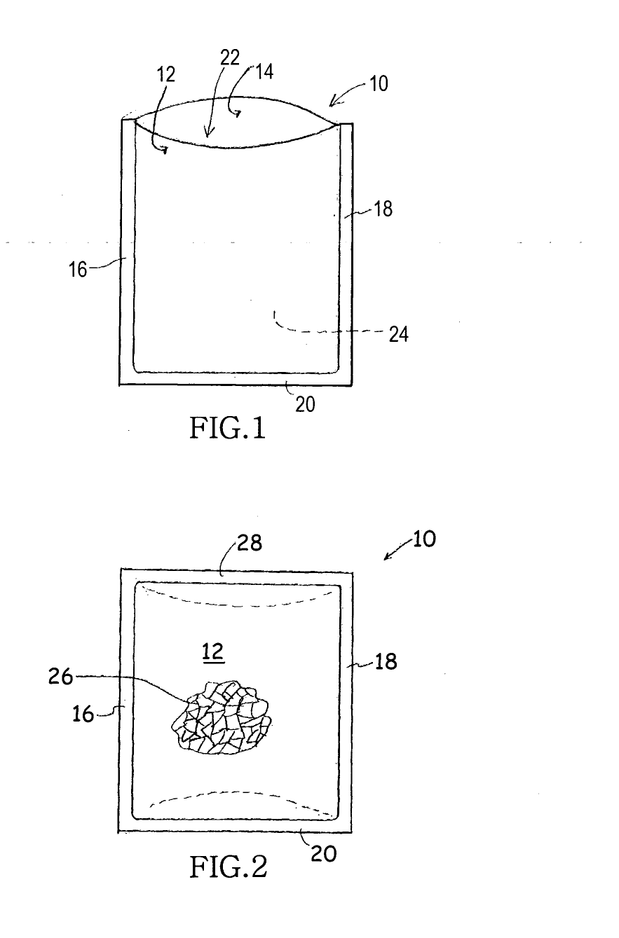

Turning now to the drawings, FIG. 1 illustrates a retort pouch 10 having a front wall 12, a back wall 14, a left side seal 16, a right side seal 18, a bottom seal 20, and an opening 22 at the top of the pouch. Opening 22 leads to the cavity 24 which receives the product which will be contained in the pouch.

FIG. 2 shows the open-top pouch of FIG. 1 after product 26 has been placed in the cavity and after the top seal 28 has been formed thereby closing and sealing the pouch.

As is common practice in retort packaging, after the pouch has been filled and sealed as represented in FIG. 2, the closed and sealed pouch, with the product contained therein, is retort processed at e.g. about 240 degrees F. to about 275 degrees F. for e.g. about 30 minutes to about 60 minutes.

The severity of the above retort environment requires that one be very selective in deciding which materials are used in retort packaging structures. All materials must be able to tolerate the extended time of exposure of the materials to the high temperatures and other conditions to which each material is exposed during the retort process. Typical failure modes of materials which are not acceptable relate to softening of the material enough to change shape, embrittlement of the material, melting of the material, delamination at surface-to-surface interfaces, cracking, crazing, tunneling, and the like. The material which is on the outer surface of the pouch/package is exposed to the highest level of thermal and other stresses whereas layers disposed inwardly of the outer layer are stressed to a lesser extent, in that the outer layer serves in a shielding capacity, shielding the more inwardly-located layers from the intensity of the thermal and physical energy at the outer surface of the package. Accordingly, any material which is to be located at or immediately adjacent the outer surface of the package must be able to tolerate the extremities of the thermal stresses which are imposed on the package during the retort cooking process.

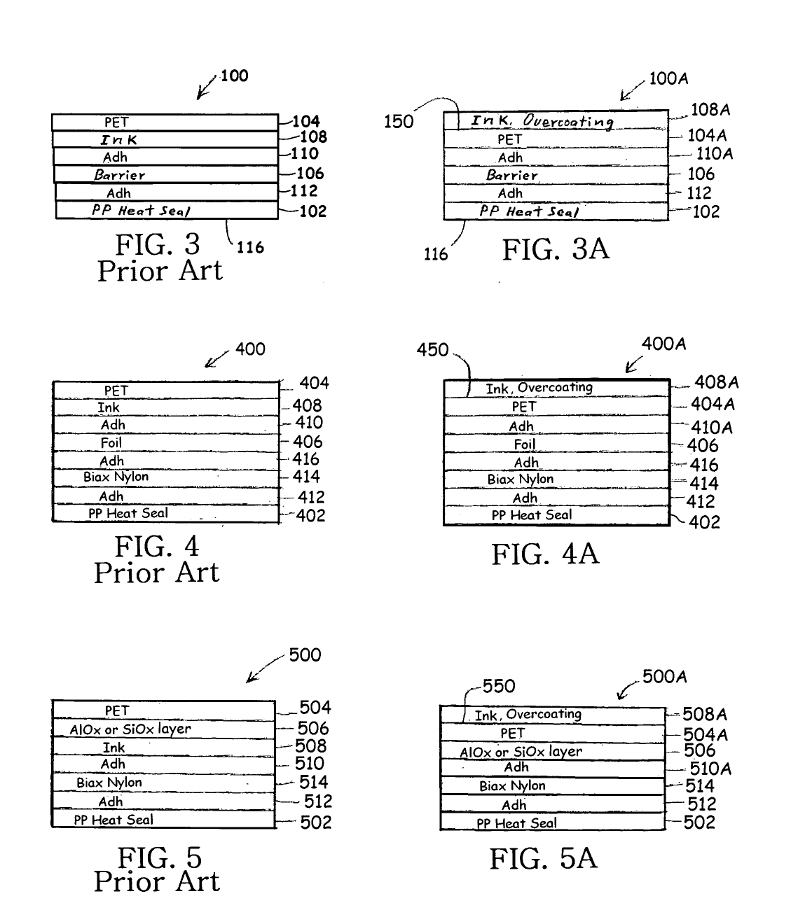

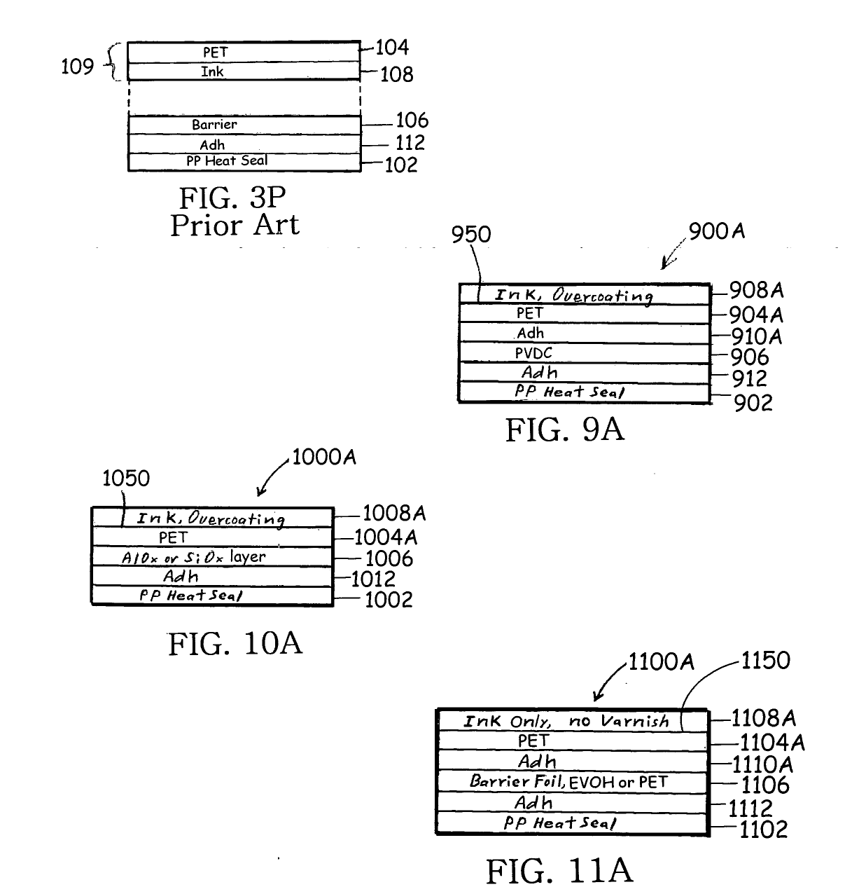

Turning now to FIG. 3 which is representative of a conventional prior art structure, the illustrated packaging structure 100 has a first surface layer 102 of a heat seal material. In a closed and sealed package, layer 102 is at the inside surface of the packaging structure, forms the closing seals, participates in defining the cavity, and is in contact with the contained product. A second and opposing surface layer 104 is on the opposite side of the packaging structure and forms the outwardly-facing layer in the closed and sealed package. As a third layer, a barrier layer 106 is located between the first surface layer 102 and the second surface layer 104.

Now addressing illustrative compositions, a typical composition for heat seal layer 102 in any retort structure is a polypropylene, particularly a biaxially oriented cast polypropylene. A typical composition for the second outwardly-facing layer 104 is polyester, particularly biaxially oriented poly(ethylene terephthalate). The third barrier layer 106 can be made from a variety of materials which are known for their ability to inhibit or stop transmission of materials into, or out of, the product-containing package. Typically, barrier layers are used to inhibit or prevent transmission of oxygen into the product-containing package, or transmission of flavor or aroma out of the package. Exemplary of such barrier materials are metal foil such as aluminum foil, certain of the polymers such as polyvinylidene chloride or ethylene vinyl alcohol copolymer, or barrier coated biaxially oriented nylon 6 or polyester, or AlOₓ, or SiOₓ.

As illustrated both in FIG. 3 and FIG. 3P, outer polyester layer 104 is reverse printed with a full or partial layer 108 of ink. By “partial” is meant that the ink need not cover the entirety of the surface of the polyester layer. Indeed, especially in structures which do not contain a metal foil layer, it can be desirable to leave a portion of the surface of the ink-receiving substrate/polyester unprinted thus to provide visual access into the interior of the package so the consumer can inspect the contents of the package prior to purchase and/or consumption of the contained product.

FIG. 3P illustrates the situation where the polyester has been reverse printed, and where the printed structure 109 has not yet been joined to the barrier layer 106. In the embodiment illustrated in FIG. 3P, the printed structure is subsequently joined to the barrier layer 106 by introducing an adhesive layer 110 between the printed polyester and the barrier layer 106, with the printed side of the polyester facing the barrier layer, as shown in FIG. 3P. Adhesive layer 110 is introduced between the polyester composite and the barrier layer in a conventional adhesive lamination process, thereby to complete formation of the prior art structure represented by FIG. 3.

Referring still to especially FIG. 3P, adhesive layer 112 is used to join barrier layer 106 to heat seal layer 102 in a corresponding adhesive lamination process. In some instances, the three primary layers in structure 100, namely the heat seal layer 102, the printed polyester layer 104, and the barrier layer 106 are collectively joined to make the finished structure 100 in a single laminating pass. The single laminating pass applies adhesive layer 112 between layers 102 and 106, and also applies, either simultaneously or in a second step, adhesive layer 110 between barrier layer 106 and printed structure 109.

Thus, as seen especially according to FIG. 3P, the adhesive joining of the structural layers to each other cannot be completed until after the polyester layer 104 is reverse-printed. However, the polyester layer 104 cannot be printed until the packaging manufacturer has received the customer's printing instructions, for example the design e.g. color, layout, and the like, of the imagery to be printed on layer 104.

FIG. 3A shows a retort structure 100A which is the same as the structure of FIG. 3 in every way with respect to heat seal layer 102, adhesive layer 112, and barrier layer 106. However, the polyester layer, denominated 104A, instead of being reverse printed, is adhesively joined directly to barrier layer 106 by adhesive layer 110A. Thus, polyester layer 104A is not joined to layer 106/110A through a printing layer. Rather, polyester layer 104A is surface printed, on that surface 150 of the polyester layer which faces away from barrier layer 106, away from heat seal layer 102, away from the surface 116 of the structure which represents the walls which define cavity 24. The printing is overcoated with a transparent, e.g. clear, colorless, solvent-less and liquidous varnish thereby to provide a generally transparent clear coat protective covering over the colorant-containing ink. Since the liquidous varnish is solvent-less, the contained precursors are substantially all converted to varnish solids in the cured condition, e.g. 100 percent of the precursors are converted to solid state.

Typically, the clear-coat varnish overcoating has a similar polymeric composition to the composition of the carrier polymer in the ink whereby, during the curing operation, the e.g. varnish overcoating typically cross-links in part, and to a detectable degree, with the deposited ink materials. The overcoating does not, however, penetrate into the ink to the extent of degrading the appearance of the printed image. But from a structural perspective, after the curing process, the boundary between the ink deposition and the overcoating deposition tends to not be a clear layer demarcation. Rather, the generally liquidous varnish appears to penetrate the generally paste-consistency ink coating sufficiently to eliminate the original physical boundary between the ink and varnish coatings, but not enough to disrupt the appearance of the printed image. The ink and overcoating are accordingly represented by a single layer indication at 108A in FIG. 3A.

In the invention, the compositions of layers 102, 112, and 106 can be exactly the same in structures of the invention as in structures of the prior art. The composition of the adhesive in layer 110A may or may not be identical to the adhesive which is used for layer 110 in FIG. 3. In some instances, it can be desirable to select a different adhesive because the adhesive is bonding directly to the polyester rather than through the ink layer.

Since the structure of FIG. 3A closely resembles the structure of FIG. 3, one can do a layer-to-layer comparison of the compositions in FIG. 3 and FIG. 3A. While it is clear that any of a variety of compositions can be used for any of the layers, an illustrative comparison is instructive.

Thus, whatever heat seal material is selected for use at 102 in the structure of FIG. 3 will typically be satisfactory for use in the structure of FIG. 3A, as to composition, as to thickness, as to method of formation of the layer, as to method of incorporating the layer into the structure. Typical material is a cast extruded polypropylene copolymer, optionally biaxially oriented, which is conventionally known as being suitable for use in fabricating retort packaging structures.

Similarly, whatever barrier material is selected for use at 106 in the structure of FIG. 3 will typically be satisfactory for use in the structure of FIG. 3A, as to composition, as to thickness, as to method of formation of the layer. Typical material for barrier layer 106 is aluminum foil, or a barrier polymer such as but not limited to poly vinylidene chloride copolymer, ethylene vinyl alcohol copolymer, Besela™, or a second layer of biaxially oriented polyester film bearing an inorganic barrier layer, or a biaxially oriented nylon 6 film bearing an inorganic barrier layer.

Besela™ is a polyethylene terephthalate-type polyester film which has been e.g. solution coated with a modified poly acrylic acid coating, and is available from Kureha Chemical Industry Company Ltd., Tokyo, Japan.

Suitable inorganic barrier layers are an aluminum oxide (AlOₓ), or a silicon oxide (SiOₓ), which has been vapor deposited or chemically deposited onto the substrate film. Examples of films bearing so-deposited inorganic layers are Techbarrier™ film from Mitsubishi Chemical, Tokyo, Japan, GL™ film from Toppan Printing, Tokyo, Japan, and Ceramis™ film from Alcan Packaging, Paris, France.

Whatever adhesive material is used for adhesive layer 112, to bond barrier layer 106 to heat seal layer 102 in FIG. 3 can as well be used in the structure 100A of FIG. 3A.

In general, the same or a similar adhesive which is used at layer 110 in the structure of FIG. 3 to bond barrier layer 106 to polyester layer 104, through the ink, can be used at 110A in the structure of FIG. 3A to bond barrier layer 106 directly to polyester layer 104. The materials used in adhesive layers 110 and 112 are commonly urethane adhesives, derived from aliphatic isocyanates and polyester polyols. Urethane adhesives which meet the government-mandated extraction requirements of e.g. 21 C.F.R 177.1390 are known to those skilled in the art. A typical such adhesive is, for example and without limitation, Adcote 76-159 or Adcote 811B, both available from Rohm and Haas Company, Philadelphia, Pa. Such adhesives can be used to bond together a wide range of materials which are compatible for use in layers 104 and 106, whereby an adhesive specified for use in a structure such as that illustrated in FIG. 3 can typically be used as well at layer 110A in the structure of FIG. 3A. On the other hand, a different adhesive is sometimes preferred since the adhesive is bonding directly to the polyester which forms the outside barrier layer.

Those skilled in the art will recognize that adhesive selection is a matter of experience, skill, and preference. Accordingly, a particular adhesive may work better in the structure and environment of FIG. 3 than in the structure and environment of FIG. 3A. Similarly, a particular adhesive may work better in the structure and environment of FIG. 3A than in the structure and environment of FIG. 3. However, the general family of adhesives useful at layer 110 for structures such as that illustrated in FIG. 3 is also useful at layer 110A for structures such as that illustrated in FIG. 3A, and those skilled in the art can select suitable adhesives for the respective structures. Those skilled in the art also recognize that each of the cross-sections shown in the drawings represents a large family of specific potential products, whereby adhesive selection can vary significantly among the respective members of the family of products.

Because the printed image in the invention of structure 100A is not reverse printed, and because the printed image is not trapped between two structural layers, bonding of the printed image to the outer surface of the substrate is critical to successful retention of the printed image in the structure. The inventors have discovered that the printed image can be successfully retained in the structure by the combination of one or more of
(i) specifying certain parameters in selection of polyester layer 104A,
(ii) specifying certain parameters in selection of the ink composition,
(iii) specifying certain parameters in selection of the composition of the overcoating material, and
(iv) specifying a sufficiently high dosage of electron beam irradiation which is used in curing the ink and varnish.

The polyester layer 104 or 104A is a pre-fabricated layer. Layer 104 or 104A is biaxially oriented in order to provide surface toughness at the nominal surface of the structure. The outer surface 150 of layer 104A has been treated to enhance the ability of the polyester to bond to materials which contact that surface of the polyester layer. Any treatment, if any is needed, which enhances the ability of the ink and varnish to bond to the polyester, sufficient to preclude delamination, bubbles, rippling, tunneling and the like in the finished coated surface, is acceptable as a surface treatment. While there can be mentioned a variety of electrical discharge treatments for enhancing bonding properties of the polyester layer, an especially effective treatment is a chemical treatment which enhances adhesion. Such polyester is available from Mitsubishi Chemical, Tokyo, Japan, under the product designation Hostephan 2CSR™, wherein the chemical treatment is believed to be an acrylic coating on the polyester. Where the coating is acrylic in nature, such acrylic coating is especially advantageous because the acrylic functionality in the acrylic coating on the polyester layer 104A can cross-link, or otherwise chemically react with, acrylic functionalities in the ink and the overcoating material, during the electron beam curing process.

Another acceptably-treated polyester is available from DuPont Company, Wilmington, Del., under the product designation Mylar™ 813.

The ink composition used in layer 108A is an E-beam-curable, retort-compatible lithographic ink, whereas a solvent-based rotogravure ink is generally used in conventional retort structures, such as at 108 in FIG. 3. By “retort compatible ink” is meant that the ink has been modified to enhance its tolerance of the high temperatures, and to enhance its tolerance for the direct contact with the water and steam at the outer surface of the package, both of which typically accompany retort processing. Thus, a typical such ink has a rather stiff, paste consistency, and employs an acrylic-based polymer in combination with a complement of colorants, as well as suitable process-enhancing additives; and has been modified to tolerate higher temperature processing and direct contact with the hot water and steam which characterize retort processing. Such ink is available, for example and without limitation, from Sun Chemical Corporation, Parsippany, N.J., as ______ and from Western Inc. (city, state) as (product name etc)______. Since inks come in various colors, the exact compositions for the respective colors of ink do vary accordingly.

The ink can be applied by conventional lithographic printing processes to achieve a high quality printed image.

The overcoating material is typically a clear, generally liquidous and highly flowable, radiation curable varnish which contains little or no colorants so as to not undesirably degrade or obscure the image presented by the ink. The varnish is typically applied over the entirety of the projected surface area of the outer polyester layer. In some embodiments, the varnish overcoating is applied to less than all of the projected surface area of the outer polyester layer in order to make the coated area appear more conspicuous than the uncoated area. The uncoated area can be printed or unprinted, or part of the uncoated area can be printed and part of the uncoated area can be unprinted. Further, part of the coated area can be printed and part of the coated area can be unprinted.

The varnish cures to a scuff resistant and abrasion resistant surface. The cured varnish should optionally provide a high gloss surface, and should be sufficiently tough to protect the ink from external abuse.

If and as desired, the overcoating can be applied to less than all of the projected surface area of polyester layer 104A thus to apply glossy highlighting to only selected portions of e.g. the printed image. However, such less-than-all application means that there may be some ink which is not protected by overcoating material whereby the scuff resistance, abrasion resistance, and retort-processing tolerance, of the graphics at the outer surface of that portion of the structure rely entirely on the scuff resistance, abrasion resistance, retort processing tolerance, of the ink.

As an alternative, the overcoating composition can be modified to affect the appearance of the overcoated layer, e.g. the ink, by (a) adding to the overcoating a small amount of colorant so as to apply an overall hue to the perceived printed image. In such instance, the colorant does not in general obscure the underlying printed image whereby the overcoating is still generally characterized as being transparent.

As yet another alternative, the overcoating can be modified by adding an e.g. inorganic filler powder to the overcoating material, which reduces the gloss appearance of the finished cured overcoating, and which thereby can provide a semi-gloss or matte or satin finish, depending on the composition of the particles, the quantity of particulate material added, the particle size, and the shapes of the particles added.

Still further, the overcoating can be modified by adding particulate metallic material/powder or flakes, especially reflective particles, so as to give the resultant overcoating a glitter effect appearance. By carefully controlling the quantity of added metallic particles, one can obtain a reflectance-enhanced affect while leaving the visibility of the underlying image largely intact.

In general, the varnish overcoating provides much the same physical protection for the ink, e.g. from external abuse, which the polyester layer provides for the ink in prior art structures such as that of FIG. 3. A typical overcoating material, as applied, will have at least some useful degree of unsaturation which can be activated, cured by the e.g. electron beam irradiation, whereby the unsaturation enables the overcoating material to cross-link to itself as well as to cross-link to the ink and optionally to the polyester e.g. through the acrylic coating on the polyester layer. For food implementations, the cured overcoating necessarily has low extractables, namely the extractables are below 50 ppb.

A suitable such overcoating is available as an acrylic-based varnish under the trade name SunBeam®LE from Sun Chemical Corporation, Parsippany, N.J.

The radiation dosage used in curing the ink and overcoating material is somewhat higher than the dosages commonly used in curing conventional inks and varnishes. While any application of energy which successfully cures both the overcoating material and the ink, so as to stabilize the ink and overcoating material in the structure, is acceptable, the inventors herein have discovered that electron beam (E-beam) irradiation is especially effective and efficient in curing the high temperature inks and varnishes which are contemplated as being useful in the invention. Accordingly, the irradiation which is applied to the coated polyester surface is about 2 mrads to about 10 mrads of irradiation. More typical intensities of irradiation are about 3 mrads to about 5 mrads.

FIG. 3A is only one illustration of a family of retort structures which can be made according to the invention. The common theme of all such structures is that a retort-ready structure can be fabricated in its entirety before any printing is applied to the structure. Indeed, as desired, the substrate can be procured from an off-site supplier, and can be placed in inventory prior to receipt of an order for a packaging product.

For example, where a certain retort structure is known to be needed periodically, and wherein the only unknown parameter is the graphics which the structure is to bear, the unprinted substrate, comprising e.g. layers 102, 112, 106, 110A, and 104A of FIG. 3A, can be obtained from e.g. a laminate supplier and stored at or near the printing facility prior to receipt of any order for such packaging material. Then, subsequent to when an order is received along with the printing specifications, the desired quantity of the stored retort substrate/structure material can be drawn from inventory, printed, overcoated, and electron-beam cured, whereupon the resultant flexible retort packaging product is ready for immediate shipment to the customer, where the packaging material will be filled with product and retort processed by the customer.

The above process has a number of advantages over the conventional process which attends the fabrication of a retort packaging structure such as the one shown in FIG. 3. For example, since the only steps which need to be performed after receipt of the order is to print and overcoat the substrate, and cure the resultant printing and overcoat, the lead time from receipt of order, to shipment of the finished packaging product, is typically shorter than if the printed polyester layer had to be adhesively laminated to the remaining portion of the structure, including several days of cure time for the adhesive.

For example, the adhesive lamination, including cure, steps are no longer part of the critical path time line since all adhesive lamination steps are performed before the order is received.

Since the adhesive lamination steps are no longer part of the critical path time line, the adhesive lamination can be performed in a different manufacturing facility, and distance from the printing and overcoating facility is, other than transportation cost, largely irrelevant.

For example, transportation of the adhesive lamination to the printing facility is not a part of the critical path.

For example, since the completed laminate/substrate can be obtained, secured as a completed whole without consideration of the imagery to be printed thereon, the printer can order larger production runs of the laminate/substrate from a supplier of such laminate/substrate in order to take advantage of economies of order size in fabrication of the entire substrate.

For example, the printer can enter the retort packaging business with a capital demand based largely on the printing operation without need to commit capital based on the adhesive lamination operation.

For example, the printer can enter the retort packaging business with a know how requirement based largely on the printing operation and a general knowledge of retort processing, without need to secure know how based on an adhesive lamination operation.

For example, assuming the printer does the surface printing with a lithographic offset process rather than a rotogravure process, the printing set-up cost is contained, while maintaining a high print quality, thus to define a cost structure which enables cost-effective production of lower quantities of a given flexible retort structure than can be done using the rotogravure process, whereby packaging users, and consumers, benefit from lower-cost entry of relatively lower-volume packaged products into the commercial marketplace.

Overall, the invention for the first time makes high quality retort packaging a cost-effective option for relatively lower volume packaged products.

Having described the invention within the context of the structure of FIG. 3A, and having compared the invention structure of FIG. 3A with the similar but different prior art structure of FIG. 3, additional examples of structures of the invention will now be described, and compared with corresponding different but similar prior art structures.

FIG. 4 shows a second prior art structure 400. Structure 400 has a polypropylene heat seal layer 402 at one of the outer surfaces of the structure. A biaxially oriented polyester layer 404 is located at, and forms, a second opposing outer surface. An aluminum foil barrier layer 406 is bonded to polyester layer 404 by adhesive layer 410, and through ink layer 408. The structure of FIG. 4 includes, in addition, a strength layer 414, optionally biaxially oriented nylon 6, which is bonded to the polypropylene heat seal layer 402 by adhesive layer 412. Strength layer 414 is bonded to foil layer 406 by an additional adhesive layer 416. By careful comparison, it is seen that the structure of FIG. 4 is in all respects the same in concept as that of FIG. 3, except for the addition of the strength layer 414. Thus, the layer compositions can be the same as in FIG. 3, allowing for adhesion of the respective adhesives to nylon layer 414.

A similar but different structure of the invention is represented at 400A by the structure illustrated in FIG. 4A. Thus, the heat seal layer 402 is the same as in FIG. 4. The biaxially oriented nylon layer 414 is the same as in FIG. 4. The aluminum foil barrier layer 406 is the same as in FIG. 4. The adhesive layers 412 and 416 are the same as in FIG. 4. The polyester layer 404A is the same as layer 104A in FIG. 3A. Namely, a polyester which has been treated for enhanced adhesion to the ink and overcoating is optionally selected for use in layer 404A. The adhesive layer 410A can be the same as the adhesive used in layer 110A or the same as the adhesive used in layer 410. Namely, the demand on the adhesive used in layer 410A draws a first demand to bond directly to polyester layer 404A as in FIG. 3A and a second demand to bond directly to the foil layer 406 as in FIG. 4. Those skilled in the art are aware of suitable e.g. food-grade adhesives which are known for their capabilities of bonding to both aluminum foil and polyester. The combination of the printed image of ink and the subsequently-applied varnish overcoating, both cured together, is illustrated as a single layer 408A. Layer 408A is fabricated and cured in the same manner as in the structure of FIG. 3A. Similarly, the polyester layer 404A has a surface 450, facing the ink and overcoating, which has been treated for enhanced adhesion of the ink and overcoating materials to the polyester layer.

FIG. 5 shows a third prior art structure 500. Structure 500 has a polypropylene heat seal layer 502 at one of the outer surfaces of the structure. A biaxially oriented polyester layer 504 is located at, and forms, a second opposing outer surface. A barrier layer 506 is mounted on polyester layer 504 on the surface of the polyester layer which is disposed toward heat seal layer 502. The composition of barrier layer 506 is an inorganic oxide, such as aluminum oxide (AlOₓ) or silicon oxide SiOₓ), which forms a glass-like barrier layer on the polyester. An ink layer 508 is mounted directly to barrier layer 506, with the barrier layer 506 between the ink layer and polyester layer 504. As in FIG. 4, the structure of FIG. 5 includes, in addition, a strength layer 514 which is bonded to the polypropylene heat seal layer 502 by adhesive layer 512. Strength layer 514 is bonded to the polyester layer indirectly, through barrier layer 506 and ink layer 508. By careful comparison, it is seen that the structure of FIG. 5 is quite similar to the structure of FIG. 4, except that the inorganic oxide layer is used in place of aluminum foil layer 406. Thus, the compositions of the layers in the structure of FIG. 5 can be the same as the compositions of the corresponding layers in FIG. 4, allowing for adhesion of the adhesive to inorganic oxide barrier layer 506.

A similar but different structure of the invention is represented at 500A by the structure illustrated in FIG. 5A. Thus, the heat seal layer 502 is the same as in FIG. 5. The biaxially oriented nylon layer 514 is the same as in FIG. 5. The inorganic oxide barrier layer 506 is the same as in FIG. 5. The adhesive layer 512 is the same as in FIG. 5. The polyester layer 504A is the same as the polyester of layer 404A in FIG. 4A. Namely, a polyester which has been treated for enhanced adhesion to the ink and overcoating is selected for use in layer 504A. The adhesive layer 510A is selected for its ability to bond to both the biaxially oriented nylon of layer 514 and its ability to bond to the combination of the polyester and the inorganic oxide layer. Typically, the adhesive used in all of layers 410A, 510, and 510A will be the same material. Those skilled in the art are aware of suitable e.g. food-grade adhesives which are known for their capabilities of bonding to both the biaxially oriented nylon and the inorganic oxide coating. The combination of the printed image of ink and the subsequently-applied varnish overcoating, both cured together, is illustrated as a single layer 508A. Layer 508A is fabricated and cured in the same manner as in the structure of FIG. 4A. Similarly, the polyester layer 504A has a surface 550, facing the ink and overcoating, which has been treated for enhanced adhesion of the ink and overcoating materials to the polyester layer.

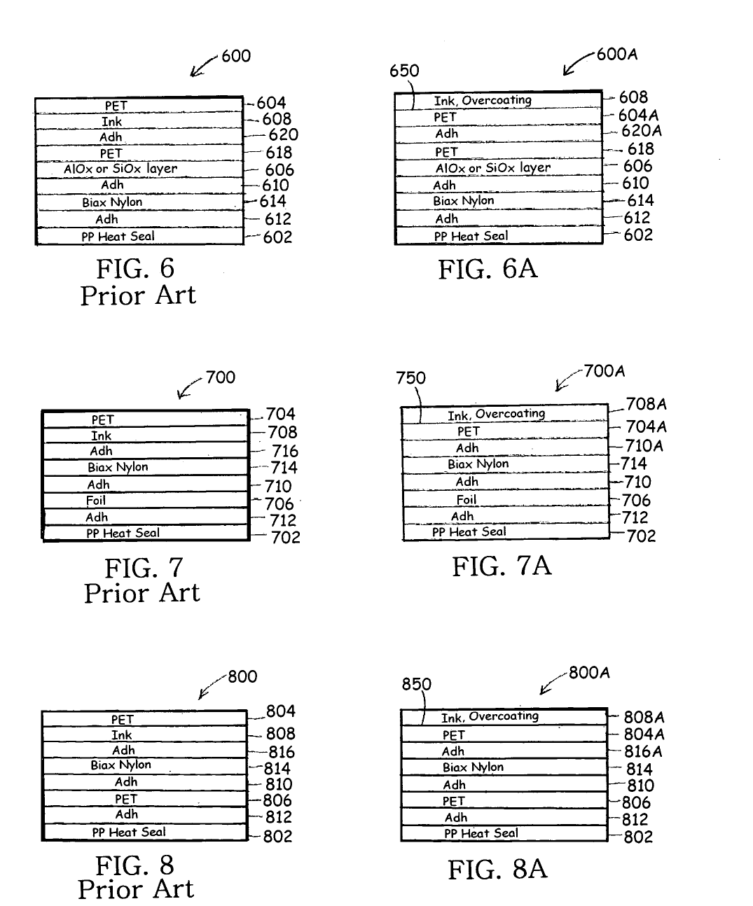

FIG. 6 shows a fourth prior art structure 600. Structure 600 has a polypropylene heat seal layer 602 at one of the outer surfaces of the structure. A biaxially oriented polyester layer 604 is located at, and forms, a second opposing outer surface. An intermediate polyester layer 618 is located between outer polyester layer 604 and heat seal layer 602, and bears an inorganic oxide barrier layer 606 such as that used in the structure of FIG. 5. An additional nylon strength layer 614 is bonded to the polypropylene heat seal layer by adhesive layer 612. An adhesive layer 610 bonds the coated polyester layer 618 to nylon layer 614. An ink layer 608 is reverse printed on polyester layer 604, and is bonded to polyester layer 618 by an adhesive layer 620. By careful comparison, it is seen that the structure of FIG. 6 is quite similar to the structure of FIG. 5, except that a second polyester layer 606, bearing an inorganic oxide layer 618, is inserted into the structure between the outer polyester layer 604 and nylon barrier layer 614, and the ink layer is mounted directly to polyester layer 604 rather than through the inorganic oxide barrier layer. Thus, the compositions of the layers in the structure of FIG. 6 can in general be the same as, or at least can be compared to, the compositions of the corresponding layers in FIG. 5.

A similar but different structure of the invention is represented at 600A by the structure illustrated in FIG. 6A. Thus, the heat seal layer 602 is the same as in FIG. 6. The biaxially oriented nylon layer 614 is the same as in FIG. 6. The inorganic oxide barrier layer 606 and the polyester layer 618 are the same as in FIG. 6. The adhesive layers 610 and 612 are the same as in FIG. 6. The polyester layer 604A is the same as layer 504A in FIG. 5A. Namely, a polyester which has been treated for enhanced adhesion to the ink and overcoating is selected for use in layer 604A. The adhesive layer 620A is selected for its ability to bond to polyester layers 604A and 618. Typically, the adhesive used in layer 620A will be the same as the adhesive used in layer 620. Those skilled in the art are aware of suitable e.g. food-grade adhesives which are known for their capabilities of cost-effectively bonding to both of the polyester layers. The combination of the printed image of ink and the subsequently applied varnish overcoating, on polyester layer 604A, both cured together, is illustrated as a single layer 608A. Layer 608A is fabricated and cured in the same manner as in the structures of FIGS. 3A, 4A, and 5A. Similarly, the polyester layer 604A has a surface 650, facing the ink and overcoating, which has been treated for enhanced adhesion of the ink and overcoating materials to the polyester layer.

FIG. 7 shows a fifth prior art structure 700. Structure 700 has a polypropylene heat seal layer 702 at one of the outer surfaces of the structure. A biaxially oriented polyester layer 704 is located at, and forms, a second opposing outer surface. An aluminum foil barrier layer 706 is disposed between heat seal layer 702 and outer polyester layer 704. A biaxially oriented nylon strength layer 714 is located between the outer polyester layer 704 and foil barrier layer 706. An adhesive layer 712 bonds the foil barrier layer to heat seal layer 702. A second adhesive layer 710 bonds the foil barrier layer 706 to the biaxially oriented nylon layer 714. Outer polyester layer 704 is reverse printed with an ink layer 708 and is bonded to nylon layer 714 by adhesive layer 716. By careful comparison, it is seen that the structure of FIG. 7 is quite similar to the structure of FIG. 4, except that foil barrier layer 706 and nylon strength layer 714 are, in FIG. 7, in the reverse order compared to the structure of FIG. 4. Thus, the compositions of the layers in the structure of FIG. 7 can in general be the same as the compositions of the corresponding layers in FIG. 4.

A similar but different structure of the invention is represented at 700A by the structure illustrated in FIG. 7A. Thus, the heat seal layer 702 is the same as in FIG. 7. The biaxially oriented nylon layer 714 is the same as in FIG. 7. The foil barrier layer 706 is the same as in FIG. 7. The adhesive layers 710 and 712 are the same as in FIG. 7. The outer polyester layer 704A is the same as layer 604A in FIG. 6A. Namely, a polyester which has been treated for enhanced adhesion to the ink and overcoating is selected for use in layer 704A. The adhesive layer 710A is selected for its ability to bond to polyester layer 704A and nylon layer 714. Typically, the adhesive used in layer 710A will be the same as the adhesive used in layer 716 in FIG. 7. Those skilled in the art are aware of suitable e.g. food-grade adhesives which are known for their capabilities of cost-effectively bonding to both the biaxially oriented polyester layer 704A and the biaxially oriented nylon layer 714. The combination of the printed image of ink and the subsequently-applied varnish overcoating, on polyester layer 704A, both cured together, is illustrated as a single layer 708A. Layer 708A is fabricated and cured in the same manner as in the structures of FIGS. 3A, 4A, 5A, and 6A. Also, the polyester layer 704A has a surface 750, facing the ink and overcoating, which has been treated for enhanced adhesion of the ink and overcoating materials to the polyester layer.

FIG. 8 shows a fifth prior art structure 800. Structure 800 has a polypropylene heat seal layer 802 at one of the outer surfaces of the structure. A biaxially oriented polyester layer 804 is located at, and forms, a second opposing outer surface. A biaxially oriented polyester barrier layer 806 is disposed between heat seal layer 802 and outer polyester layer 804. A biaxially oriented nylon strength layer 814 is located between the outer polyester layer 804 and polyester barrier layer 806. An adhesive layer 812 bonds the polyester barrier layer 806 to heat seal layer 802. A second adhesive layer 810 bonds the polyester barrier layer 806 to the biaxially oriented nylon layer 814. Outer polyester layer 804 is reverse printed with an ink layer 808 and is bonded to nylon layer 814 by adhesive layer 816. By careful comparison, it is seen that the structure of FIG. 8 is quite similar to the structure of FIG. 7, except that foil barrier layer 706 of the structure of FIG. 7 is replaced by the biaxially oriented polyester layer 806. Thus, the compositions of the layers in the structure of FIG. 8 can in general be the same as the compositions of the corresponding layers in FIG. 7.

A similar but different structure of the invention is represented at 800A by the structure illustrated in FIG. 8A. Thus, the heat seal layer 802 is the same as in FIG. 8. The biaxially oriented nylon layer 814 is the same as in FIG. 8. Polyester layer 806 is the same as in FIG. 8. Adhesive layers 810 and 812 are the same as in FIG. 8. The outer polyester layer 804A is the same as layer 704A in FIG. 7A. Namely, a polyester which has been treated for enhanced adhesion to the ink and overcoating is selected for use in layer 804A. The adhesive layer 816A is selected for its ability to bond to polyester layer 804A and nylon layer 814 and can be the same as the adhesive used in layer 710A in FIG. 7. Typically, the adhesive used in layer 816A will be the same as the adhesive used in layer 816 in FIG. 8. Those skilled in the art are aware of suitable e.g. food-grade adhesives which are known for their capabilities of cost-effectively bonding to both the biaxially oriented polyester layer 804A and the biaxially oriented nylon layer 814. The combination of the printed image of ink and the subsequently applied overcoating, on polyester layer 804A, both cured together, is illustrated as a single layer 808A. Layer 808A is fabricated and cured in the same manner as in the structures of FIGS. 3A, 4A, 5A, 6A and 7A. Also, the polyester layer 804A has a surface 850, facing the ink and overcoating, which has been treated for enhanced adhesion of the ink and overcoating materials to the polyester layer.

A further embodiment of structures of the invention is represented at 900A by the structure illustrated in FIG. 9A. Thus, the heat seal layer 902 is the same as in e.g. FIG. 8A. The outer polyester layer 904A is the same as layer 804A in FIG. 8A. Namely, a polyester which has been treated for enhanced adhesion to the ink and overcoating is selected for use in layer 904A. The barrier layer 906 is in this case polyvinylidene chloride copolymer (PVdC). Adhesive layer 912 is selected for its ability bond to both the polypropylene heat seal layer 902 and PVdC layer 906. Adhesive layer 910A is selected for its ability to bond to polyester layer 904A and PVdC layer 906. Those skilled in the art are aware of suitable e.g. food-grade adhesives which are known for their capabilities of cost-effectively bonding to both the respective polypropylene, PVdC, and polyester layers. The combination of the printed image of ink and the subsequently applied overcoating, on polyester layer 904A, both cured together, is illustrated as a single layer 908A. Layer 908A is fabricated and cured in the same manner as in the structures of e.g. FIGS. 3A, 4A, 5A, 6A 7A, and 8A. Also, the polyester layer 904A has a surface 950, facing the ink and overcoating, which has been treated for enhanced adhesion of the ink and overcoating materials to the polyester layer.

A further embodiment of structures of the invention is represented at 1000A by the structure illustrated in FIG. 10A. Thus, the heat seal layer 1002 is the same as layer 902 in FIG. 9A. The outer polyester layer 1004A is the same as layer 904A in FIG. 9A. Namely, a polyester which has been treated for enhanced adhesion to the ink and overcoating is selected for use in layer 1004A. The barrier layer 1006 is in this case a layer of AlOₓ or SiOₓ applied directly to polyester layer 1004A, the same as the corresponding layer e.g. 506 in structure 500A. Adhesive layer 1012 is selected for its ability to bond to both the coated polyester layer 1004A and to the polypropylene heat seal layer 1002. Those skilled in the art are aware of suitable e.g. food-grade adhesives which are known for their capabilities of cost-effectively bonding to both the polypropylene layer and the coated polyester layer. The combination of the printed image of ink and the subsequently applied varnish overcoating, on polyester layer 1004A, both cured together, is illustrated as a single layer 1008A. Layer 1008A is fabricated and cured in the same manner as in the structures of e.g. FIGS. 3A, 4A, 5A, 6A 7A, 8A, and 9A. Also, the polyester layer 1004A has a surface 1050, facing the ink and overcoating, which has been treated for enhanced adhesion of the ink and overcoating materials to the polyester layer.

A further embodiment of structures of the invention is represented at 1100A by the structure illustrated in FIG. 11A. Thus, the heat seal layer 1102 is the same as in e.g. FIG. 10A. The outer polyester layer 1104A is the same as layer 1004A in FIG. 10A. Namely, a polyester which has been treated for enhanced adhesion to the ink and overcoating is selected for use in layer 1104A. The barrier layer 1106 can be any of the barrier materials mentioned earlier, for example and without limitation metal foil, biaxially oriented polyester, or PVdC, or an inorganic oxide barrier material. Adhesive layer 1112 is selected for its ability bond to both polypropylene heat seal layer 1102 and to the material of barrier layer 1106. Adhesive layer 1110A is selected for its ability to bond to polyester layer 1104A and the respective barrier layer material. Those skilled in the art are aware of suitable e.g. food-grade adhesives which are known for their capabilities of cost-effectively bonding to the corresponding polypropylene, polyester, and barrier materials. In this embodiment, overcoating layer 1108A is defined entirely by the ink coating. No varnish overcoating is used in this family of embodiments. Rather, the ink contains sufficient polymer carrier to, without further overcoating, protect the colorant in the ink which defines the image presented by the ink. Layer 1108A is fabricated and cured in the same manner as in the structures of e.g. FIGS. 3A, 4A, 5A, 6A 7A, 8A, 9A, and 10A except that no overcoating is used. Also, the polyester layer 1104A has a surface 1150, facing the ink and overcoating, which has been treated for enhanced adhesion of the ink materials to the polyester layer.

Thus, FIG. 11A illustrates the concept that the varnish overcoating can be omitted where the ink is sufficiently robust in its polymer content, and wherein the ink layer is sufficiently thick, that the image is appropriately protected by the ink polymer, such that no overcoating is needed.

Overall thickness of retort structures of the invention is about 2 mils thick to about 20 mils thick, optionally about 4 mils thick to about 10 mils thick, optionally about 4.5 mils thick to about 6 mils thick. Typically the polyester layers are biaxially oriented and are about 0.25 mil to about 0.75 ml, more typically about 0.5 ml, optionally 0.48 mil. Optionally, the nylon layers are biaxially oriented and are about 0.25 mil to about 1.0 mil, optionally about 0.6 mil to about 1.0 mil thick. The heat seal layer is about 30 percent to about 75 percent of the overall thickness of the structure, typically about 40 percent to about 60 percent of the overall thickness of the structure. Foil layers are typically about 0.35 mil thick.

While exemplary thicknesses and materials are disclosed herein for the substrate, any known retort-compatible substrate can be employed as a substrate onto which the ink and optional overcoating are applied. Thus, for example and without limitation, in FIG. 3A, layers 102, 112, 106, 110A and 104A are considered to define the substrate. Similarly, in FIG. 8A, layers 802, 812, 806, 810, 814, 816A, and 804A are considered to define the substrate.

The above exemplary structures are made of materials which are typically suitable for use in retort substrates, such as those which can be used in structures of the invention.

The compositions of the printable surface layer, e.g. polyester layers, can generally be any biaxially oriented polyester which is adapted and configured to tolerate retort processing, and, as to surface polyester layers, which has been optionally suitably treated for enhanced adhesion of the ink, e.g. an acrylic ink.

As stated earlier, the invention can be employed using any substrate structure which can function in a retort environment. To that end, other materials which have suitable properties of e.g. ink adhesion and toughness can be used in place of the polyester material in the print surface layer such as 804A, 704A and the like. Exemplary of such other materials are, without limitation, nylon 6 and nylon 66, especially e.g. biaxially oriented embodiments of such materials.

The compositions of the nylon layers can generally be any e.g. oriented, nylon which is adapted and configured to tolerate retort processing, namely the relatively higher temperature nylons, and are commonly based on nylon 6 or nylon 66.

The compositions of the heat seal layers can generally be any material which is adapted and configured to tolerate retort processing, and which is suitably soft to tolerate the flexing to which the structure will be exposed during the expected use life of the packaging material. Commonly used polymers are random or impact copolymers of polypropylene and other olefinic polymers and polymer fragments such as rubber components, for example isoprene, butadiene, and the like. The heat seal layer is typically a cast extruded film.

As desired, other food-grade materials which are known to be heat sealable and which tolerate retort conditions, can be used in the heat seal layer. Exemplary such other materials are, for example and without limitation, propylene ethylene copolymers. Other examples of heat seal materials which can be used in retort structures are taught in, without limitation, U.S. Pat. No. 4,311,742; U.S. Pat. No. 4,405,667; U.S. Pat. No. 4,407,873; U.S. Pat. No. 5,160,767; U.S. Pat. No. 6,110,549; and U.S. Pat. No. 6,599,639, all of which are incorporated herein by reference regarding teachings of heat seal layers useful in retort structures.

The sealant layer is typically about 2 mils thick to about 5 mils thick, optionally about 3 mils thick to about 4 mils thick, typically thinner if a foil layer is used in the substrate construct.

The adhesives layers are quite thin, typically about 2 pounds to about 4 pounds, optionally about 2.5 pounds to about 3 pounds, per 3000 square foot ream.

Now addressing specifically the ink, the prior art structures use an exemplary ink which is characterized as 108, 308, 408, and the like. Such ink is typically an acrylic-based rotogravure ink. The inks used in the invention, by contrast, are lithographic inks which have been modified to withstand the extreme temperature and time conditions which attend being exposed, on the surface of the package, to retort processing. The inks of the invention are surface printed onto the outer surface of the outer layer of polyester, rather than being reverse printed and then buried in the retort structure between a polyester layer and the heat seal layer, with various intervening layers between the ink layer and the heat seal layer. The surface printed inks and overcoat are cured by electron beam radiation, e.g. E-beam radiation.

The varnish overcoating is typically applied at a rate which results in a cured coating which is about 15 gauge to about 50 gauge thick, optionally about 20 gauge to about 30 gauge, with an exemplary thickness of about 25 gauge (0.00025 inch thick).

All of the materials used in retort structures of the invention, as well as the structures themselves, must meet or exceed the extractables requirements of 21 C.F.R. 177.1390, and the finished retort structures must survive their expected use lives with no loss of adhesion between respective ones of the layers of the retort structure.

While the above description has focused on a flexible retort package, the technology disclosed here can as well be used in retort packages wherein only a portion of the package, such as a lid, is flexible material of the invention, and wherein a remainder of the package is represented by a more rigid material such as a tray or a dish or the like. For example, such tray or dish can be made of polymeric materials, but with thicker cross-section. Representative of such package is a tray which has sealed to it a lid which is representative of the invention.

In referring herein to an acrylic layer, an acrylic ink, or an acrylic or varnish coating/overcoating, it is intended to include both the cross-linked finished acrylic/varnish composition and the pre-cursors of such acrylic/varnish compositions which are converted to the finished acrylic/varnish composition during fabrication of the retort packaging structure.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. A retortable flexible packaging structure, comprising:
(a) a multiple layer substrate which, when assembled into a retortable package, is compatible with retort processing, said multiple layer substrate having a first surface which is defined by a first surface layer which is heat sealable, and a second opposing outer surface defined by a second surface layer, said second surface layer having an outer surface which corresponds with the second outer surface of said substrate; and
(b) a first coating on the second outer surface of said multiple layer substrate, said first coating comprising a printed image, said printed image having been derived from a reaction-curable ink,
said printed and overcoated flexible packaging structure, when assembled into a retort package, being compatible with being retort processed.

2. A retortable flexible packaging structure as in claim 1 wherein said one or more reaction curable ink precursors were reactable such that substantially all of such reaction curable ink precursors were converted to solid state when cured.

3. A retortable flexible packaging structure as in claim 1 wherein said one or more reaction curable ink precursors comprise E-beam curable ink precursors.

4. A retortable flexible packaging structure as in claim 1, further comprising an overcoating overlying said printed image, said overcoating having been derived from one or more reaction curable overcoating precursors, and wherein said one or more reaction curable overcoating precursors are reactable such that substantially 100 percent of such reaction curable overcoating precursors are converted to solid state when cured.

5. A retortable flexible packaging structure as in claim 1 wherein the outer surface of said second layer bears the results of a surface treatment which enhances adhesion of the respective outer surface with respect to certain materials which contact the respective treated outer surface.

6. A retortable flexible packaging structure as in claim 5 wherein the surface treatment comprises a chemical treatment.

7. A retortable flexible packaging structure as in claim 6 wherein the chemical treatment comprises an acrylic or pre-acrylic treatment.

8. A retortable flexible packaging structure as in claim 1 wherein said first coating on the second surface reflects having been electron-beam cured at a dosage of about 2 mega rads to about 10 mega rads.

9. A retortable flexible packaging structure as in claim 1 wherein composition of said second surface layer comprises at least one of polyester and nylon.

10. A retortable flexible packaging structure as in claim 1 wherein composition of said second surface layer comprises at least one of oriented polyethylene terephthalate and oriented nylon.

11. A retortable flexible packaging structure as in claim 1 wherein composition of said second surface layer comprises oriented polyethylene terephthalate.

12. A retortable flexible packaging structure as in claim 1, further comprising an overcoating overlying said printed image, and wherein said overcoating was derived from a radiation curable transparent polymeric material precursor.

13. A retortable flexible packaging structure as in claim 12 wherein said radiation curable transparent polymeric material comprises a varnish.

14. A retortable flexible packaging structure as in claim 1 wherein said retortable flexible package structure has an average thickness of about 0.0025 inch to about 0.020 inch.

15. A retortable flexible packaging structure as in claim 1 wherein said retortable flexible package structure has an average thickness of about 0.004 inch to about 0.010 inch.

16. A retortable flexible packaging structure as in claim 1 wherein said retortable flexible package structure has an average thickness of about 0.0045 inch to about 0.006 inch.

17. A retortable flexible packaging structure as in claim 4, said overcoating having been derived from one or more E-beam curable overcoating precursor.

18. A retortable flexible packaging structure as in claim 1, said multiple layer substrate further comprising a barrier layer, said barrier layer comprising a material selected from the group consisting of a metal foil layer, polyvinylidene chloride copolymer, ethylene vinyl alcohol copolymer, a polyester layer having a solution coated modified acrylic coating, an AlOₓ layer, and a SiOₓ layer.

19. A retort package, comprising:
(a) packaging, said packaging comprising a retortable multiple layer flexible packaging structure comprising
(i) a substrate, said substrate comprising an outer structural layer, said outer structural layer having an inwardly-facing surface facing toward an inner cavity in said retort package and an outwardly-facing surface facing away from said retort package, and
(ii) a first coating being disposed on the outwardly-facing surface of said substrate, said first coating comprising a printed image, said printed image having been derived from a reaction curable ink precursor,
said multiple layer flexible packaging structure reflecting having been retort processed; and
(b) a retort-processed commercially sterile product contained in said package.

20. A retort package as in claim 19 wherein such reaction curable ink precursor is reactable such that substantially all of such reaction curable ink precursor is converted to solid state when cured.

21. A retort package as in claim 19 wherein such reaction curable ink precursor comprises an E-beam curable ink precursor.

22. A retort package as in claim 19, further comprising an overcoating overlying the printed image, said overcoating having been derived from a reaction curable overcoating precursor, and wherein such reaction curable overcoating precursor was reactable such that substantially all of such reaction curable overcoating precursor was converted to solid state when cured.

23. A retort package as in claim 19 wherein the outwardly-facing surface of said outer structural layer bears the results of a surface treatment which enhances adhesion of the respective outwardly-facing surface with respect to certain materials which contact the respective outwardly-facing surface.

24. A retort package as in claim 23 wherein the surface treatment comprises a chemical treatment.

25. A retort package as in claim 24 wherein the chemical treatment comprises an acrylic or pre-acrylic treatment.

26. A retort package as in claim 19 wherein said first coating on the outwardly-facing surface reflects having been electron-beam cured at a dosage of about 2 mega rads to about 10 mega rads.

27. A retort package as in claim 19, further comprising an overcoating overlying the printed image, and wherein said overcoating was derived from a radiation curable transparent polymeric material

28. A retort package as in claim 27 wherein said radiation curable transparent polymeric material comprises a varnish.

29. A retort package structure as in claim 19 wherein composition of said outer structural layer comprises at least one of polyester and nylon.

30. A retort package as in claim 19 wherein composition of said outer structural layer comprises at least one of oriented polyethylene terephthalate and oriented nylon.

31. A retort package as in claim 19 wherein composition of said outer structural layer comprises oriented polyethylene terephthalate.

32. A retort package as in claim 19 where said substrate has an average thickness of about 0.0025 inch to about 0.020 inch.

33. A retort package as in claim 19 where said substrate has an average thickness of about 0.004 inch to about 0.010 inch.

34. A retort package as in claim 19 where said substrate has an average thickness of about 0.0045 inch to about 0.006 inch.

35. A retort package as in claim 19, said substrate further comprising a barrier layer, said barrier layer comprising a material selected from the group consisting of a metal foil layer, polyvinylidene chloride copolymer, ethylene vinyl alcohol copolymer, a polyester layer having a solution coated modified acrylic coating, an AlOₓ layer, and a SiOₓ layer.

36. A method of producing retortable flexible packaging structure, comprising:
(a) securing a supply of a multiple layer substrate material which, when assembled into a retortable package, is compatible with retort processing, the multiple layer substrate having a first outer surface which is defined by a first surface layer which is heat sealable, and a second opposing outer surface which is defined by a second surface layer, the second surface layer having an outer surface which corresponds with the second outer surface of the substrate material;
(b) making a first draw of less than all of the supply of substrate material from the supply, and coating a first printed image onto the second outer surface of the first drawn substrate material, optionally applying an overcoating over the first printed image, using first printing machinery, and ink, thus to make a first finished flexible retort packaging structure which, when assembled into a retort package, is compatible with being retort processed;
(c) sending the first finished flexible retort packaging structure to a first user of flexible retort packaging structure;
(d) making a second draw of the substrate material from the supply of substrate material, and coating a second printed image onto the second outer surface of the second drawn substrate material, optionally applying an overcoating over the second printed image, using second printing machinery, and ink, thus to make a second finished flexible retort packaging structure which, when assembled into a retort package, is compatible with being retort processed; and
(e) sending the second finished flexible retort packaging structure to a second user of flexible retort packaging structure,
the method further comprising at least one of
(i) the second printed image is different from the first printed image, or
(ii) the second user is different from the first user, or
(iii) the second printing machinery is the same as the first printing machinery, further comprising printing a different product on the respective printing machinery between printing the first and second printed images.

37. A method as in claim 36 wherein the substrate has an average thickness of about 0.0025 inch to about 0.020 inch.

38. A method as in claim 36 wherein the substrate has an average thickness of about 0.004 inch to about 0.010 inch.

39. A method as in claim 36 wherein the substrate has an average thickness of about 0.0045 inch to about 0.06 inch.

40. A method as in claim 36 wherein the composition of said second surface layer comprises at least one of polyester and nylon.

41. A method as in claim 36 wherein the composition of said second surface layer comprises at least one of oriented polyethylene terephthalate and oriented nylon.

42. A method as in claim 36 wherein the composition of said second surface layer comprises oriented polyethylene terephthalate.

43. A method as in claim 36 wherein the inks are reactable such that substantially all of the inks are converted to solid state when cured.

44. A method as in claim 36 wherein the inks are E-beam curable inks.

45. A method as in claim 36 wherein the optional overcoatings are reactable such that substantially all of the overcoating is converted to solid state when cured.

46. A method as in claim 36 wherein the optional overcoatings are E-beam curable overcoatings.

47. A method as in claim 36, further comprising treating the second outer surface with a surface treatment which enhances adhesion of the second outer surface with respect to the inks.

48. A method as in claim 36, further comprising treating the second outer surface with a chemical surface treatment which enhances adhesion of the second outer surface with respect to the inks.

49. A method as in claim 36, further comprising treating the second outer surface with an acrylic or pre-acrylic surface treatment which enhances adhesion of the second outer surface with respect to the inks.

50. A method as in claim 36, the multiple layer substrate material further comprising a barrier layer, the barrier layer comprising a material selected from the group consisting of a metal foil layer, polyvinylidene chloride copolymer, ethylene vinyl alcohol copolymer, a polyester layer having a solution coated modified acrylic coating, an Alex layer, and a SiOₓ layer.

51. A method of producing a retortable flexible packaging structure, comprising:
(a) securing a supply of a multiple layer substrate material which is compatible with retort processing when assembled into a retortable package, the multiple layer substrate having a first outer surface, defined by a first surface layer which is heat sealable, and a second opposing outer surface which is defined by a second surface layer, the second surface layer having an outer surface which corresponds with the second outer surface of the substrate material;
(b) surface printing an ink image on the second outer surface at the second surface layer; and
(c) curing the printed ink image by exposing the printed ink image to electron-beam irradiation of about 2 mega rads to about 10 mega rads and thereby obtaining a cured ink coating which is tolerant of retort processing,
thereby obtaining a retortable flexible packaging structure which, when assembled into a retortable package, is compatible with being retort processed.

52. A method as in claim 51, further comprising, prior to curing the printed ink image, overcoating the printed ink image with an E-beam curable transparent overcoating, and subsequently practicing the curing step by simultaneously exposing both the printed ink image and the overcoating to E-beam radiation at an irradiation dosage of about 2 mega rads to about 10 mega rads.

53. A method as in claim 51 wherein the substrate has an average thickness of about 0.0025 inch to about 0.020 inch.

54. A method as in claim 51 wherein the substrate has an average thickness of about 0.004 inch to about 0.010 inch.

55. A method as in claim 51 wherein the substrate has an average thickness of about 0.0045 inch to about 0.006 inch.

56. A method as in claim 51 wherein the composition of said second surface layer comprises at least one of polyester and nylon.

57. A method as in claim 51 wherein the composition of said second surface layer comprises at least one of oriented polyethylene terephthalate and oriented nylon.

58. A method as in claim 51 wherein the composition of said second surface layer comprises oriented polyethylene terephthalate.

59. A method as in claim 51 wherein the ink is reactable such that substantially all of the ink is converted to solid state when cured.

60. A method as in claim 51 wherein the ink is E-beam curable ink.

61. A method as in claim 51, further comprising treating the second outer surface with a surface treatment which enhances adhesion of the second outer surfaces with respect to the ink.

62. A method as in claim 51, further comprising treating the second outer surface with a chemical surface treatment which enhances adhesion of the second outer surface with respect to the ink.

63. A method as in claim 51, further comprising treating the second outer surface with an acrylic or pre-acrylic surface treatment which enhances adhesion of the second outer surface with respect to the ink.

64. A method as in claim 51, the multiple layer substrate material further comprising a barrier layer, the barrier layer comprising a material selected from the group consisting of a metal foil layer, polyvinylidene chloride copolymer, ethylene vinyl alcohol copolymer, a polyester layer having a solution coated modified acrylic coating, an AlOₓ layer, and a SiOₓ layer.

65. A method of making a flexible retortable packaging structure, comprising:
(a) securing a supply of a flexible packaging substrate which, when assembled into a retortable package, is compatible with retort processing, said flexible packaging substrate having a first outer surface which is defined by a first layer which is heat sealable, and a second opposing outer surface which is defined by a second surface layer, said second surface layer having an outer surface which corresponds with the second outer surface of the flexible packaging substrate;
(b) after securing the supply of substrate, identifying a quantity of a product to be produced using the substrate;
(c) printing a printed image on the second outer surface, using E-beam curable ink;
(d) overcoating the printed image with a second E-beam curable overcoating material; and
(e) E-beam curing both the E-beam curable ink and the E-beam curable overcoating material,
thereby obtaining a retortable packaging structure, including substrate, E-beam cured ink, and E-beam cured overcoating over the E-beam cured ink, and wherein the retortable packaging structure, when assembled into a retortable package, is compatible with retort processing.

66. A method as in claim 65 wherein the substrate has an average thickness of about 0.0025 inch to about 0.020 inch.

67. A method as in claim 65 wherein the substrate has an average thickness of about 0.004 inch to about 0.010 inch.

68. A method as in claim 65 wherein the substrate has an average thickness of about 0.0045 inch to about 0.006 inch.

69. A method as in claim 65 wherein the composition of said second surface layer comprises at least one of polyester and nylon.

70. A method as in claim 65 wherein the composition of said second surface layer comprises at least one of oriented polyethylene terephthalate and oriented nylon.

71. A method as in claim 65 wherein the composition of said second surface layer comprises oriented polyethylene terephthalate.

72. A method as in claim 65 wherein the ink is reactable such that substantially all of the ink is converted to solid state when cured.

73. A method as in claim 65, further comprising treating the second outer surface with a surface treatment which enhances adhesion of the second outer surfaces with respect to the ink.

74. A method as in claim 65, further comprising treating the second outer surface with a chemical surface treatment which enhances adhesion of the second outer surface with respect to the ink.

75. A method as in claim 65, further comprising treating the second outer surface with an acrylic or pre-acrylic surface treatment which enhances adhesion of the second outer surface with respect to the ink.

76. A method as in claim 65, the flexible packaging substrate further comprising a barrier layer, the barrier layer comprising a material selected from the group consisting of a metal foil layer, polyvinylidene chloride copolymer, ethylene vinyl alcohol copolymer, a polyester layer having a solution coated modified acrylic coating, an AlOₓ layer, and a SiOₓ layer.

77. A method of making a flexible retortable package, comprising:
(a) securing a supply of a flexible packaging substrate which, when assembled into a retortable package, is compatible with retort processing, said flexible packaging substrate having a first outer surface which is defined by a first layer which is heat sealable, and a second opposing outer surface which is defined by a second surface layer, said second surface layer having an outer surface which corresponds with the second outer surface of the flexible packaging substrate;
(b) after securing the supply of substrate, identifying a quantity of a product to be produced using the substrate;
(c) printing a printed image on the second outer surface, using E-beam curable ink;
(d) overcoating the printed image with a second E-beam curable overcoating material;
(e) E-beam curing both the E-beam curable ink and the E-beam curable overcoating material; and
(f) heat sealing portions of the heat sealable layer thereby to fabricate a resultant retortable package, the package defining a product-receiving cavity, and an opening extending from the cavity to the outside environment,
the resultant retortable package being compatible with retort processing.

78. A method as in claim 77 wherein the substrate has an average thickness of about 0.0025 inch to about 0.020 inch.

79. A method as in claim 77 wherein the substrate has an average thickness of about 0.004 inch to about 0.010 inch.

80. A method as in claim 77 wherein the substrate has an average thickness of about 0.0045 inch to about 0.006 inch.

81. A method as in claim 77 wherein the composition of said second surface layer comprises at least one of polyester and nylon.

82. A method as in claim 77 wherein the composition of said second surface layer comprises at least one of oriented polyethylene terephthalate and oriented nylon.

83. A method as in claim 77 wherein the composition of said second surface layer comprises oriented polyethylene terephthalate.

84. A method as in claim 77 wherein the ink is reactable such that substantially all of the ink is converted to solid state when cured.

85. A method as in claim 77, further comprising treating the second outer surface with a surface treatment which enhances adhesion of the second outer surfaces with respect to the ink.

86. A method as in claim 77, further comprising treating the second outer surface with a chemical surface treatment which enhances adhesion of the second outer surface with respect to the ink.

87. A method as in claim 77, further comprising treating the second outer surface with an acrylic or pre-acrylic surface treatment which enhances adhesion of the second outer surface with respect to the ink.

88. A method as in claim 77, the flexible packaging substrate further comprising a barrier layer, the barrier layer comprising a material selected from the group consisting of a metal foil layer, polyvinylidene chloride copolymer, ethylene vinyl alcohol copolymer, a polyester layer having a solution coated modified acrylic coating, an AlOₓ layer, and a SiOₓ layer.

89. A packaged food product, comprising:
(a) A food product;
(b) a retortable packaging structure enclosing the food product, said packaging structure comprising:
(i) a substrate film comprising one or more thermoplastic materials, and optionally a barrier layer, said substrate film having a print side, and an opposing food side and an average thickness of less than about 0.025 inch, said substrate film, when assembled into a retort package, being compatible with being heat sealed to itself, and tolerating retort processing;
(ii) an image printed on the print side of said substrate film;
(iii) an E-beam-cured overcoating over the printed image, said E-beam-cured coating having been formed by
coating the printed image with an E-beam-curable overcoating material comprising one or more polymerizable reactants, wherein the E-beam-curable overcoating material includes less than about 20 percent by weight monofunctional monomer based on weight of the E-beam-curable overcoating material, and
subsequently exposing the E-beam-curable overcoating material to radiation sufficient to polymerize at least 90 percent by weight of the one or more polymerizable reactants,
and wherein, when the coated, printed, and cured film is tested according to the FDA migration test protocol, no more than 50 parts per billion total of any of the polymerizable reactants migrate within 10 days at 40 degrees C. from the coated, printed package into a food stimulant selected from the group consisting of (i) 95 weight percent ethanol and 5 weight percent water and (ii) 5 weight percent ethanol and 95 weight percent water, the food stimulant being enclosed within a test container formed from the coated, printed film so that the food stimulant contacts the food side of the substrate film and the ratio of volume of food stimulant to surface area of coated, printed film is 10 milliliters per square inch.

90. A packaged food product as in claim 89 wherein
the package comprises one or more heat-sealed regions,
at least a portion of the E-beam-cured overcoating material extends into the heat-sealed region, and
the weight of the E-beam-cured overcoating material per unit area of substrate film in the portion of the E-beam-cured overcoating material extending into the heat-sealed region is at least substantially equal to the weight of the E-beam-cured overcoating material per unit area of substrate film outside the heat-sealed region.

91. A packaged food product as in claim 89 wherein
the package comprises one or more heat-sealed regions,
at least a portion of the printed image extends into the heat-sealed region, and
the weight of printed image per unit area of substrate film of the portion of the printed image extending into the heat-sealed region is at least substantially equal to the weight of printed image per unit area of substrate film outside the heat-sealed region.

92. A packaged food product as in claim 89 wherein
the package further comprises one or more heat-sealed regions, and
the gloss of the coated, printed film in the heat-sealed regions is at least substantially equal to the gloss of the coated, printed film outside the heat-sealed region.

93. A packaged food product as in claim 89 wherein the substrate film has an average thickness of about 0.0025 inch to about 0.020 inch.

94. A packaged food product as in claim 89 wherein the substrate film has an average thickness of about 0.004 inch to about 0.010 inch.

95. A packaged food product as in claim 89 wherein the substrate film has an average thickness of about 0.0045 inch to about 0.006 inch.

96. A packaged food product as in claim 89 wherein the package enclosing the food product comprises a vertical form-fill-sealed package or a horizontal form-fill-seal package, optionally a pre-made pouch open on one side before filling with food.

97. A packaged food product as in claim 89 wherein the package enclosing the food product includes a lid comprising the coated, printed film.

98. A packaged food product as in claim 89 wherein the average thickness of the E-beam cured overcoating material is less than about 5 micrometers.

99. A packaged food product as in claim 89 wherein said E-beam curable overcoating material, prior to curing, comprises less than 20 percent by weight reactant diluent based on the weight of the E-beam curable overcoating material.

100. A packaged food product as in claim 89 wherein said E-beam curable overcoating material, prior to curing, comprises less than about 10 percent by weight monofunctional monomer based on the weight of the E-beam curable overcoating material.

101. A packaged food product as in claim 89 wherein said E-beam curable overcoating material, prior to curing, comprises less than about 5 percent by weight monofunctional monomer based on the weight of the E-beam curable overcoating material.

102. A packaged food product as in claim 89 wherein said E-beam curable overcoating material, prior to curing, is essentially free from monofunctional monomer.

103. A packaged food product as in claim 89 wherein said E-beam curable overcoating material, prior to curing, is essentially free from reactive diluent.

104. A packaged food product as in claim 89, further comprising an outer layer defining the print side of said substrate film and wherein the composition of said outer layer comprises at least one of polyester and nylon.

105. A packaged food product as in claim 89, further comprising an outer layer defining the print side of said substrate film and wherein the composition of said outer layer comprises at least one of oriented polyethylene terephthalate and oriented nylon.

106. A packaged food product as in claim 89, further comprising an outer layer defining the print side of said substrate film and wherein the composition of said outer layer comprises oriented polyethylene terephthalate.

107. A packaged food product as in claim 89 wherein said printed image is derived from one or more reaction curable ink precursors which are reactable such that substantially all of such reaction curable ink precursors are converted to solid state when cured.

108. A packaged food product as in claim 107 wherein said one or more reaction curable ink precursors comprise E-beam curable ink precursors.

109. A packaged food product as in claim 89, said E-beam-cured overcoating having been derived from one or more overcoating precursors and wherein substantially all of such overcoating precursors have been converted to solid state by the E-beam-curing process.

110. A packaged food product as in claim 89 wherein said printed image reflects having been E-beam-cured at a dosage of about 2 mega rads to about 10 mega rads.

111. A packaged food product as in claim 89 wherein said E-beam-cured overcoating is derived from a transparent polymeric material precursor.

112. A packaged food product as in claim 89 wherein said E-beam-cured overcoating comprises a varnish.

113. A packaged food product as in claim 89 wherein said barrier layer comprises a material selected from the group consisting of a metal foil layer, polyvinylidene chloride copolymer, ethylene vinyl alcohol copolymer, a polyester layer having a solution coated modified acrylic coating, an AlOₓ layer, and a SiOₓ layer.

114. A method of packaging food, comprising:
(a) providing a substrate film comprising one or more thermoplastic materials, and optionally a barrier layer, the substrate film having a print side and an opposing food side, and having an average thickness of less than about 0.025 inch, such substrate film, when assembled into a retort package, being compatible with being heat sealed to itself, and tolerating retort processing;
(b) printing an image on the print side of the substrate film;
(c) coating the printed image with an E-beam-curable overcoating material comprising one or more polymerizable reactants, wherein the E-beam-curable overcoating material comprises less than about 20 percent by weight monofunctional monomer based on the weight of the E-beam-curable overcoating material;
(d) subsequently exposing the E-beam-curable overcoating material to E-beam radiation sufficient to polymerize at least 90 percent by weight of the one or more polymerizable reactants to produce a coated, printed film comprising an E-beam-cured overcoating material, and wherein
when the coated, printed, and cured film is tested according to the FDA migration test protocol, no more than 50 parts per billion total of any of the polymerizable reactants migrate within 10 days at 40 degrees C. from the coated, printed film into a food simulant selected from the group consisting of (i) 95 percent by weight ethanol and 5 percent by weight water and (ii) 5 weight percent ethanol and 95 percent by weight water, the food simulant being enclosed within a test container formed from the coated, printed film so that the food simulant contacts the food side of the substrate film and the ratio of volume of food simulant to surface area of coated, printed film is 10 milliliters per square inch;
(e) forming a package comprising the coated, printed film; and
(f) enclosing a food within the package so that the food side of the substrate film faces the enclosed food.

115. A method as in claim 114 wherein the forming step comprises heat sealing the coated, printed film to form one or more heat-sealed regions, wherein at least a portion of the E-beam cured overcoating material extends into the heat-sealed region and the weight of the E-beam-cured overcoating material per unit area of substrate film in the portion of the E-beam-cured overcoating material extending into the heat-sealed region is at least equal to the weight of the E-beam-cured overcoating material per unit area of substrate film outside the heat-sealed region.

116. A method as in claim 114 wherein the forming step comprises heat sealing the coated, printed film to form one or more heat-sealed regions, wherein at least a portion of the E-beam cured printed image extends into the heat-sealed region and the weight of the E-beam-cured printed image per unit area of substrate film in the portion of the E-beam-cured printed image extending into the heat-sealed region is at least equal to the weight of the E-beam-cured printed image per unit area of substrate film outside the heat-sealed region.

117. A method as in claim 114 wherein the substrate film has an average thickness of about 0.0025 inch to about 0.020 inch.

118. A method as in claim 114 wherein the substrate film has an average thickness of about 0.004 inch to about 0.010 inch.

119. A method as in claim 114 wherein the substrate film has an average thickness of about 0.0045 inch to about 0.006 inch.

120. A method as in claim 114 wherein the printing comprises applying one or more E-beam-curable inks to the print side of the substrate film and applying E-beam radiation and thereby curing the one or more inks.

121. A method as in claim 114 wherein forming the package comprises making a vertical form-fill-sealed package or a horizontal form-fill-seal package, or a pre-made pouch open on one side before filling with food.

122. A method as in claim 114 wherein the package comprises a lid comprising the printed and overcoated film.

123. A method as in claim 114 wherein average thickness of the E-beam-cured overcoating material is no more than about 5 micrometers.

124. A method as in claim 114 wherein the E-beam-curable overcoating material comprises less than 20 percent by weight reactant diluent based on the weight of the E-beam-curable overcoating material.

125. A method as in claim 114 wherein the E-beam-curable overcoating material comprises less than about 10 percent by weight monofunctional monomer based on the weight of the E-beam-curable overcoating material.

126. A method as in claim 114 wherein the E-beam-curable overcoating material comprises less than about 5 percent by weight monofunctional monomer based on the weight of the E-beam-curable overcoating material.

127. A method as in claim 114 wherein the E-beam-curable overcoating material comprises less than about 2 percent by weight monofunctional monomer based on the weight of the E-beam-curable overcoating material.

128. A method as in claim 114 wherein the E-beam-curable overcoating material is essentially free from monofunctional monomer.

129. A method as in claim 114 wherein the E-beam-curable overcoating material is essentially free from reactive diluent.

130. A method as in claim 114, further comprising heating the package at retort conditions of greater than 212 degrees F. for at least about 10 minutes, thereby to commercially sterilize the food contained in the package.

131. A method as in claim 114, further comprising an outer layer on the print side of said substrate film and wherein the composition of the outer layer comprises at least one of polyester and nylon.

132. A method as in claim 114, further comprising an outer layer on the print side of the substrate film and wherein the composition of the outer layer comprises at least one of oriented polyethylene terephthalate and oriented nylon.

133. A method as in claim 114, further comprising an outer layer on the print side of said substrate film and wherein the composition of said outer layer comprises oriented polyethylene terephthalate.

134. A method as in claim 114 wherein the printed image is derived from an ink which is reaction curable such that substantially all of the ink is converted to solid state when cured.

135. A method as in claim 114 wherein the ink is E-beam-curable ink.

136. A method as in claim 114 wherein the printed image is derived from ink, further comprising treating the print side with a surface treatment which enhances adhesion of the print side with respect to the ink.

137. A method as in claim 114, further comprising treating the print side with a chemical surface treatment.

138. A method as in claim 114, further comprising treating the print side with an acrylic or pre-acrylic surface treatment.

139. A method as in claim 114 wherein said barrier layer comprises a material selected from the group consisting of a metal foil layer, polyvinylidene chloride copolymer, ethylene vinyl alcohol copolymer, a polyester layer having a solution coated modified acrylic coating, an AlOₓ layer, and a SiOₓ layer.

140. A packaged food product, comprising:
(a) a food product;
(b) a retortable package enclosing the food product, said retortable package comprising a coated, printed film comprising
(i) a retortable substrate film comprising one or more thermoplastic materials, and optionally a barrier layer, said retortable substrate film having a print side and an opposing food side and an average thickness of less than about 0.025 inch, and being compatible with being heat sealed to itself, and tolerating retort processing,
(ii) a retortable image printed on the print side of said retortable substrate film, and
(iii) a retortable E-beam-cured overcoating over the printed image, said retortable E-beam-cured coating having been formed by
coating the printed image with an E-beam-curable coating comprising one or more polymerizable reactants and optionally one or more photoinitiators, and
subsequently exposing the E-beam-curable coating to radiation sufficient to polymerize at least 90 percent by weight of the polymerizable reactants,
wherein said package comprises one or more heat-sealed regions and at least a portion of the E-beam-cured overcoating extends into the heat-sealed region, and
wherein the weight of the E-beam-cured overcoating per unit area of substrate film in the portion of the E-beam-cured overcoating extending into the heat-sealed region is at least substantially equal to the weight of E-beam-cured overcoating per unit area of substrate film outside of the heat-sealed region.

141. A packaged food product as in claim 140 wherein
at least a portion of the printed image extends into the heat-sealed region, and
weight of printed image per unit area of substrate film of a portion of the printed image which extends into the heat-sealed region is at least substantially equal to an average weight of printed image per unit area of substrate film outside the heat-sealed region.

142. A packaged food product as in claim 140 wherein the package enclosing the food product comprises a vertical form-fill-sealed package or a horizontal form-fill-seal package, or a pre-made pouch open on one side before filling with food.

143. A packaged food product as in claim 140 wherein the package enclosing the food product includes a lid comprising the coated, printed film.

144. A packaged food product as in claim 140 wherein said retortable printed, coated substrate film has a thickness of about 0.0025 inch to about 0.020 inch.

145. A packaged food product as in claim 140 wherein said retortable printed, coated substrate film has a thickness of about 0.004 inch to about 0.010 inch.

146. A packaged food product as in claim 140 wherein said retortable printed, coated substrate film has a thickness of about 0.0045 inch to about 0.006 inch.

147. A packaged food product as in claim 140, further comprising an outer layer on the print side of said substrate film and wherein the composition of said outer layer comprises at least one of polyester and nylon.

148. A packaged food product as in claim 140, further comprising an outer layer on the print side of said substrate film and wherein the composition of said outer layer comprises at least one of oriented polyethylene terephthalate and oriented nylon.

149. A packaged food product as in claim 140, further comprising an outer layer on the print side of said substrate film and wherein the composition of said outer layer comprises oriented polyethylene terephthalate.

150. A packaged food product as in claim 140 wherein said printed image is derived from one or more reaction curable ink precursors which are reactable such that substantially all of such reaction curable ink precursors are converted to solid state when cured.

151. A packaged food product as in claim 140 wherein said one or more reaction curable ink precursors comprise E-beam curable ink precursors.

152. A packaged food product as in claim 140, said E-beam-cured overcoating having been derived from one or more overcoating precursors and wherein substantially all of such overcoating precursors have been converted to solid state by the E-beam-curing process.

153. A packaged food product as in claim 140 wherein said printed image reflects having been E-beam-cured at a dosage of about 2 mega rads to about 10 mega rads.

154. A packaged food product as in claim 140 wherein said E-beam-cured overcoating is derived from a transparent polymeric material precursor.

155. A packaged food product as in claim 140 wherein said E-beam-cured overcoating comprises a varnish.

156. A packaged food product as in claim 140 wherein said barrier layer comprises a material selected from the group consisting of a metal foil layer, polyvinylidene chloride copolymer, ethylene vinyl alcohol copolymer, a polyester layer having a solution coated modified acrylic coating, an AlOₓ layer, and a SiOₓ layer.
